(19) United States
(12) Patent Application Publication
(10) Pub. No.: US 2025/0312700 A1
(43) Pub. Date: Oct. 9, 2025

(54) Method and apparatus for contest creation based on security markets and portfolio selection.

(71) Applicant: Finium LLC, Beltsville, MD (US)

(72) Inventors: Josh Marvel, Beltsville, MD (US); Joseph Luquette, Damascus, MD (US)

(21) Appl. No.: 19/097,767

(22) Filed: Apr. 1, 2025

Related U.S. Application Data
(60) Provisional application No. 63/574,204, filed on Apr. 3, 2024.

(51) Int. Cl. A63F 13/69; G06Q 40/06

(52) U.S. Cl. CPC A63F 13/69; G06Q 40/06

(57) ABSTRACT

The present disclosure relates to systems and methods for managing structured simulations using real-time data processing and automated ranking. The technique may involve receiving at least one simulation initialization parameter from a first user device, wherein the simulation initialization parameter defines a simulation structure including a predefined number of participants, an open selection pool of geography-linked selections, one or more scoring metrics, and a simulation duration. Participants may select one or more geography-linked selections. The technique may include retrieving real-time performance data from at least one external data source and applying a predefined computation rule to dynamically update a performance ranking for participant aggregated distribution weightings. The ranking data may be stored in a structured database and used to generate a dynamically updating simulation leaderboard accessible via a publicly available simulation tracking interface. The leaderboard may rank participants based on real-time performance indicator values.

### REFERENCE TO RELATED APPLICATIONS

This application claims priority from U.S. provisional application Ser. No. 63/574,204, filed Apr. 3, 2024, which is incorporated by reference.

### BACKGROUND OF THE INVENTION

The present disclosure generally relates to computer-implemented methods and systems for creating, managing, and executing structured educational simulations using real-time data, automated performance tracking, and configurable simulation mechanics.

### DESCRIPTION OF THE RELATED ART

Existing simulation-based platforms and simulation systems often rely on manual tracking methods or generic game structures that do not provide real-time rankings, customizable simulation rules, or automated performance calculations. Many traditional simulation platforms require participants to track their progress manually, making them difficult to scale for broader engagement in educational, professional, or community-based settings.

### SUMMARY OF THE INVENTION

In some aspects, the techniques described herein relate to at least one non-transitory machine-readable medium including instructions, which when executed by processing circuitry, cause the processing circuitry to perform operations to: receive at least one simulation initialization parameter associated with a simulation from a first user device, wherein the at least one simulation initialization parameter defines a simulation structure including a predefined number of simulation participants, an open selection pool of a plurality of geography-linked selections, one or more scoring metrics based on at least one real-time data input, and a simulation duration; store the at least one simulation initialization parameter in a structured database, wherein each simulation is assigned a unique simulation identifier; receive participant selection data, the participant selection data corresponding to at least one predefined simulation rule and including a selection of at least one geography-linked selection, wherein the selection of at least one geography-linked selection may be chosen by one or more participant aggregated distribution weightings; associate the participant selection data with the unique simulation identifier to generate a relational mapping of the one or more participant aggregated distribution weightings within the structured database; obtain the at least one real-time data input from at least one external data source, wherein the at least one external data source provides dynamically updating performance indicator values corresponding to the participant selection data; apply at least one predefined computation rule to the at least one real-time data input to generate a performance ranking for the one or more participant aggregated distribution weightings, wherein the performance ranking is dynamically updated throughout the simulation duration; assign a ranking position to the one or more participant aggregated distribution weightings based on the performance ranking; and generate a publicly accessible simulation tracking interface including a simulation leaderboard, wherein the simulation leaderboard dynamically updates the performance ranking of the one or more participant aggregated distribution weightings based on the at least one real-time data input.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a computing hardware architecture diagram, according to various examples.

FIG. 2 illustrates a system architecture of a user device, according to various examples.

FIG. 3 illustrates a diagram of a simulation platform architecture, according to various examples.

FIG. 4 illustrates a network entity diagram depicting multiple entities communicating via a network, according to various examples.

FIG. 5 illustrates a simulation platform architecture, according to various examples.

FIGS. 6A-6D illustrate a graphical user interface for a simulation platform, according to various examples.

FIG. 7 illustrates a flowchart depicting a technique for managing a simulation platform.

FIG. 8 illustrates a set of illustrative icons representing various cognitive biases that may be introduced into an industrial and international educational simulation platform, according to various examples.

### DETAILED DESCRIPTION

Systems and techniques described herein may be used to overcome the limitations of traditional methods for organizing, managing, and tracking structured simulations, particularly those reliant on static event-based scoring, closed selection pools, or rigid simulation structures. Unlike traditional fantasy sports platforms, where participants draft exclusive selections from a limited pool of pre-defined athletes and compete in head-to-head matchups, the disclosed system enables an open selection pool, allowing multiple participants to choose the same geography-linked selections. Conventional systems often lack real-time performance updates, impose strict selection constraints, and limit adaptability to diverse competitive environments. The disclosed technique supports dynamically updating analytics monitors, seamless simulation and tracking, and flexible simulation durations untethered to scheduled sporting events, making it applicable across culturally and/or socially dispersed industries, diverse financial markets, predictive modeling, and other data-driven domains.

To address these issues, a system for creating, executing, and managing structured simulations using a web-based platform with automated performance tracking and configurable simulation mechanics is disclosed. Unlike fantasy sports leagues that operate on a fixed schedule based on real-world sporting events, this system allows simulation organizers to establish simulations with customizable timeframes and dynamically updating scoring metrics. Participants may select from an open pool of geography-linked selections, where multiple participants may hold the same selection without exclusive drafting constraints. The system automatically retrieves external real-time performance data, applies predefined computation rules, and updates participant rankings dynamically. Participants may monitor simulation standings via a continuously updating leaderboard instead of engaging in discrete head-to-head matchups.

An example technique may include receiving at least one simulation initialization parameter associated with a simulation from a first user device. The simulation initialization parameter may define a simulation structure, including a predefined number of participants, an open selection pool of geography-linked selections, one or more scoring metrics based on real-time data inputs, and a simulation duration that is not restricted to a fixed schedule. The system may store the simulation initialization parameter in a structured database, wherein each simulation is assigned a unique simulation identifier. Unlike traditional fantasy sports drafts, where selections are exclusive, participant selection data may be received in a manner that allows multiple participants to select the same asset within a given simulation. The system may then associate the participant selection data with the unique simulation identifier, generating a relational mapping of participant aggregated distribution weightings within the structured database. The system may present novice participants with an optional list of ‘hot ticker’ suggestions. By offering a short list of commonly discussed or trending assets, new users may quickly select entries while learning through active engagement and competitive play. The platform may encourage education and exploration by combining this ‘quick-pick’ mechanism with ongoing discussions in a shared chat or ‘tribe’ environment.

To ensure participant privacy and anonymity, the simulation platform may allow users to sign up and authenticate through the application without exposing personally identifiable information to other participants within the simulation. Each participant may be assigned a unique simulation identifier or username, which is used solely for tracking selections and performance rankings. In some embodiments, students and/or users may be prevented from changing their username. In some aspects, this may be in order to provide integrity and/or continuity, which may enhance the learning experience and/or Socratic dialogues.

The platform may prevent direct association of real-world identities with in-simulation decisions, maintaining an anonymous environment where selections, aggregated distribution weightings, and rankings are displayed without revealing participant details. In some examples, the platform may incorporate additional privacy controls, such as pseudonym generation, restricted leaderboards, or randomized display orders, to further enhance anonymity and prevent reverse identification.

In certain embodiments, the simulation platform may incorporate a chat function or social forum specifically designed to foster user interaction, including casual ‘trash talk,’ real-time sharing of experiences, and learning-by-doing. Participants may question each other's picks, debate strategies, and receive informal coaching from more experienced users. This social dynamic may provide a strong educational dimension, as users may observe real-world outcomes of both successful and unsuccessful picks.

In some examples, the chat function may be restricted to authenticated participants of the respective simulation and is not visible to the general public or to users who have not joined the specific simulation. This ensures that the communication remains private and relevant to the active simulation context. The system may enforce access controls by validating session tokens or participant identifiers prior to allowing chat visibility or interaction.

Once the simulation is underway, the system may compute at least one real-time data input from an external data source, where the external data source may provide one or more performance indicator values corresponding to the participant selection data. Unlike fantasy sports platforms, where scoring is derived from pre-defined sports statistics within a single event, the disclosed system retrieves continuous, dynamically updating performance data, ensuring rankings reflect real-time fluctuations rather than static, game-based results. A predefined computation rule may then be applied to the real-time data input to generate a performance ranking for a participant aggregated distribution weighting. The system may assign a ranking position to each participant aggregated distribution weighting based on the computed performance ranking and generate a publicly accessible simulation tracking interface that includes a leaderboard ranking all participants simultaneously rather than individual matchups.

In some embodiments, the system may allow participants to select long or short positions for geography-linked selections. The scoring engine may apply symmetrical or asymmetrical weighting coefficients to reflect the inherent risk of shorting or to balance volatility exposure. This may ensure that riskier strategies are evaluated fairly and encourages informed selection behavior within the simulation environment.

The simulation leaderboard may be formatted using at least one visual highlighting technique to differentiate ranking positions based on performance, ensuring a dynamic and engaging tracking experience. Unlike fantasy sports leaderboards, which are often segmented into smaller league-based simulations, the disclosed simulation platform may provide a global ranking interface accessible to all participants within a simulation. A unique URL associated with the simulation leaderboard may be transmitted to a second user device, providing real-time access to simulation standings without requiring manual updates. The system may generate system notifications upon detecting any modifications to simulation rules or participant rankings, ensuring that users remain informed of simulation developments. Automated alerts may be sent to user devices, further enhancing engagement and transparency.

In some embodiments, the system may award digital trophies or achievement badges to participants based on milestones such as completing a simulation, achieving a top ranking, or demonstrating consistent engagement. These awards may be displayed on the participant's profile page and may serve as visual markers of reputation or accomplishment within the platform. Achievement criteria may be predefined by simulation organizers or system administrators.

In some examples, the system may generate visual representations of simulation performance trends by displaying aggregated distribution weightings as they dynamically update over time. These visualizations may use color-coded schemes or gradient-based indicators to signify variations in magnitude or rate of change. For example, a linear or order-of-magnitude-based gradient may be applied to highlight percentage deltas in weightings across different time intervals. This dynamic visualization approach may allow participants and observers to intuitively grasp shifting trends, performance variations, and evolving participant distributions within the simulation, enhancing engagement and analytical insight.

The system may implement safeguards to mitigate user-identity or brand impersonation concerns. For example, an individual might attempt to pose as a well-known fund or analyst. Although the platform is not intended to promote the creation of analysts or official funds, it may offer optional verification steps, disclaimers, or automated checks that reduce the risk of impersonation. Users are encouraged to treat all commentary as anonymous peer input rather than professional advice. Attempted misuse may be flagged, thereby helping protect against deepfake or name-cloning scenarios that may otherwise mislead participants.

In some embodiments, a ‘benchmark bot’ or a global performance reference mechanism may be included. However, establishing a single universal benchmark remains challenging, especially across multiple international indices. Future versions of the system may add bond instruments or multi-regional baskets to generate a more statistically representative global ‘standard.’ Until then, organizers may select specific blended indices or even a predominantly U.S.-centered basket augmented by one or more non-U.S. markers.

Consider a scenario where a social work organization seeks to engage community members in a skills-based volunteer challenge designed to encourage civic engagement and measurable impact. Unlike traditional volunteer tracking methods, which often rely on manual reporting, static leaderboards, or periodic updates, the disclosed system enables a real-time, dynamically updating simulation that reflects participant contributions as they happen. The organization may set up a challenge where participants select their own areas of impact-such as tutoring hours provided, meals distributed, or families assisted-from an open selection pool rather than being assigned predefined roles. Unlike conventional ranking systems that use fixed-point scoring, multiple participants may contribute to the same cause and have their impact measured collectively or individually, ensuring that recognition is based on true contribution rather than exclusivity.

Using the disclosed system, simulation organizers define participation rules, configure real-time performance metrics, and establish an automated simulation portal where volunteers log activities. Instead of tracking progress manually, an external data source (such as verified nonprofit reporting tools or digital check-ins) may be integrated to provide real-time validation of contributions. A predefined computation rule then dynamically updates participant rankings based on the impact metrics, with performance continuously evolving instead of being fixed to a single event or reporting period.

While financial markets can, in theory, provide near-24-hour data for certain instruments, the disclosed system may enforce fixed participation or ‘start/stop’ schedules to mirror recognized exchange hours or simulation deadlines. This approach simplifies user engagement and reduces confusion around overnight price swings, thus letting participants concentrate on structured, daytime-focused simulation windows.

Further enhancements may include gathering user feedback or short ‘pop-up’ simulations that last only hours, enabling rapid entry-and-exit scenarios against an AI or bot entity. Future releases may incorporate crypto assets or option-based simulations, where implied volatility rankings may help participants evaluate short-selling or option-writing strategies. As these expansions develop, the system may draw on outside domain expertise or dedicated partner APIs to refine real-time short calculations, volatility indicators, or specialized risk metrics.”

A publicly accessible leaderboard allows stakeholders, sponsors, and the broader community to track contributions transparently, reinforcing accountability and engagement. Unlike traditional competitive structures that focus on head-to-head results, this system enables collaborative simulation, where participants are ranked in an inclusive, dynamically updating environment rather than a static, win-lose framework. System notifications and automated alerts ensure that volunteers remain informed about milestones, new engagement opportunities, and major progress updates.

The following description provides examples of systems and methods for creating, managing, and tracking structured simulations using a web-based platform. The disclosed embodiments are illustrative and not limiting of the scope, applicability, or examples set forth in the claims. Modifications may be made in the function and arrangement of elements without departing from the scope of the disclosure. Various examples may omit, substitute, or add procedures or components as appropriate. For example, the methods described may be performed in an order different from that presented, and steps may be added, omitted, or combined. Features described with respect to some examples may be combined in other examples. An apparatus may be implemented or a method practiced using any number of aspects set forth herein. The scope of the disclosure is intended to cover such apparatuses or methods practiced using other structures, functionalities, or combinations thereof, in addition to or other than those set forth herein. It should be understood that any aspect of the disclosure may be embodied by one or more elements of a claim. The term “exemplary” is used herein to mean “serving as an example, example, or illustration,” and does not indicate preference or superiority.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number include the plural or singular number respectively. The words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but may mean a singular element.

The illustrative embodiments are described with respect to certain types of machines. The illustrative embodiments are described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts may be selected within the scope of the illustrative embodiments.

The illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. The illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. A particular illustrative embodiment may have some, all, or none of the advantages listed above.

The illustrative embodiments are described with respect to certain types of machines. The illustrative embodiments are described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts may be selected within the scope of the illustrative embodiments.

The illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. The illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. A particular illustrative embodiment may have some, all, or none of the advantages listed above.

Various processes described herein may be implemented by appropriately programmed general purpose computers, special purpose computers, and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that may implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on an Intel® or AMD® processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

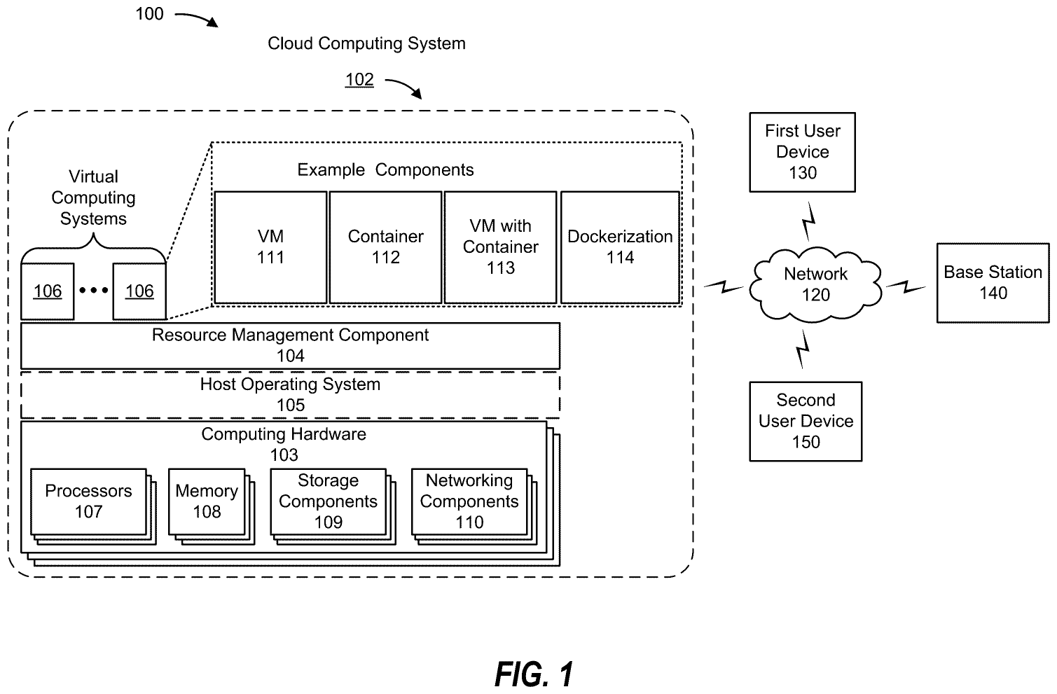

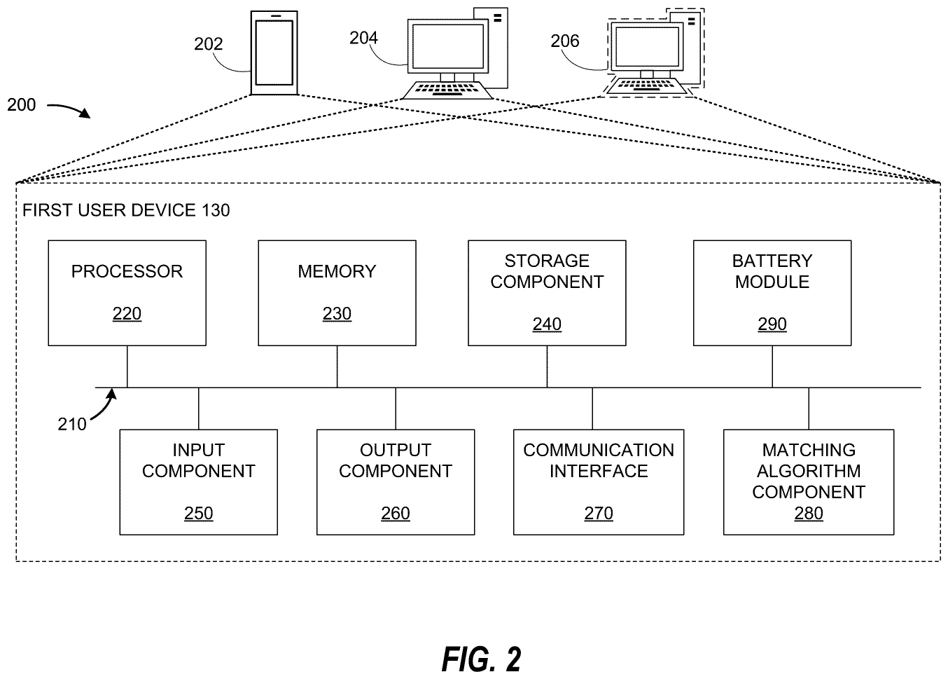

With reference to the figures and in particular, with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 is a diagram of an example environment 100 in which systems and/or methods described herein may be implemented. As shown in FIG. 1, the environment 100 may execute within a cloud computing system 102. The cloud computing system 102 may include one or more elements 103-113, as described in more detail below. As further shown in FIG. 1, the environment 100 may include a network 120, a network devices 130, and/or a base station 140. Devices and/or elements of the environment 100 may interconnect via wired connections and/or wireless connections. It is important to note that network devices 130, as described herein, is a user device which may be used by the first user and/or the second user. In the later case, when it is used by the second user, user device 130 may be called a second user device 130. For purposes of convenience in reading this description, the embodiment of the user device 130 as a first user device will be described, but it should be understood as interchangeably termed “second user device” at least for the purposes of the disclosures of FIG. 1 and FIG. 2.

The cloud computing system 102 includes computing hardware 103, a resource management component 104, a host operating system (OS) 105, and/or one or more virtual computing systems 106. The resource management component 104 may perform virtualization (e.g., abstraction) of the computing hardware 103 to create the one or more virtual computing systems 106. Using virtualization, the resource management component 104 enables a single computing device (e.g., a computer, a server, and/or the like) to operate like multiple computing devices, such as by creating multiple isolated virtual computing systems 106 from the computing hardware 103 of the single computing device. In this way, the computing hardware 103 may operate more efficiently, with lower power consumption, higher reliability, higher availability, higher utilization, greater flexibility, and lower cost than using separate computing devices.

The computing hardware 103 includes hardware and corresponding resources from one or more computing devices. For example, the computing hardware 103 may include hardware from a single computing device (e.g., a single server) or from multiple computing devices (e.g., multiple servers), such as multiple computing devices in one or more data centers. As shown, the computing hardware 103 may include one or more processors 107, one or more memories 108, one or more storage components 109, and/or one or more networking components 110. Examples of a processor, a memory, a storage component, and a networking component (e.g., a communication component) are described elsewhere herein.

The resource management component 104 includes a virtualization application (e.g., executing on hardware, such as the computing hardware 103) capable of virtualizing the computing hardware 103 to start, stop, and/or manage the one or more virtual computing systems 106. For example, the resource management component 104 may include a hypervisor (e.g., a bare-metal or Type 1 hypervisor, a hosted or Type 2 hypervisor, and/or the like) or a virtual machine monitor, such as when the virtual computing systems 106 are virtual machines 111. Additionally, or alternatively, the resource management component 104 may include a container manager, such as when the virtual computing systems 106 are containers 112. In some implementations, the resource management component 104 executes within and/or in coordination with a host operating system 105.

A virtual computing system 106 includes a virtual environment that enables cloud-based execution of operations and/or processes described herein using computing hardware 103. As shown, the virtual computing system 106 may include a virtual machine 111, a container 112, a hybrid environment 113 that includes a virtual machine and a container, an environment which includes Docker-like filesystems or other possible Dockerization 114 with a VM or other computing hardware allocation, and/or the like. A virtual computing system 106 may execute one or more applications using a file system that includes binary files, software libraries, and/or other resources required to execute applications on a guest operating system (e.g., within the virtual computing system 106) or the host operating system 105.

The network 120 includes one or more wired and/or wireless networks. For example, the network 120 may include a cellular network, a public land mobile network (PLMN), a local area network (LAN), a wide area network (WAN), a satellite network, a private network, the Internet, and/or the like, and/or a combination of these or other types of networks. The network 120 enables communication among the devices of the environment 100.

Network devices 130 may be possessed by a first user and includes one or more devices capable of receiving, generating, storing, processing, and/or providing information, as described elsewhere herein. Network devices 130 may include a communication device and/or a computing device. For example, network devices 130 may include a wireless communication device, a mobile phone, a user equipment (UE), a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The base station 140 may support, for example, a cellular radio access technology (RAT). The base station may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that may support wireless communication for the base station 140. The network devices 130 may transfer traffic between the base station 140 (e.g., using a cellular RAT), one or more base stations (e.g., using a wireless interface or a backhaul interface, such as a wired backhaul interface), and/or a core network. The network devices 130 may provide one or more cells that cover geographic areas.

The user device 150 may be possessed by a second user and includes one or more devices capable of receiving, generating, storing, processing, and/or providing information, as described elsewhere herein. User device 150 may include a communication device and/or a computing device, and may be connected to, or embedded anywhere within, a vehicle or other equipment known to be utilized in the transportation industry. For example, user device 150 may include a wireless communication device, a mobile phone, a vehicle computer system, a mobile printer, a calculator, a user equipment, a laptop computer, a tablet computer, a desktop computer, a set-top box, a wearable communication device (e.g., a smart wristwatch, a pair of smart eyeglasses, a head mounted display, or a virtual reality headset), or a similar type of device.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

FIG. 2 is a diagram of components of network devices 130, according to an example of the present disclosure. Network devices 130 may include a bus 210, a processor 220, a memory 230, a storage component 240, an input component 250, an output component 260, a communication interface 270, a battery module 290 and a matching algorithm component 280.

Bus 210 includes a component that permits communication among the components of Network devices 130. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. Memory 230 may include one or more memories such as a random access memory (RAM), a read only memory (ROM), and/or another type of dynamic or static storage device (e.g., a flash memory, a magnetic memory, and/or an optical memory) that stores information and/or instructions for use by processor 220. In some embodiments, a non-transitory computer-readable medium stores instructions that, when executed by a processor, cause the processor to perform various functions.

Storage component 240 stores information and/or software related to the operation and use of Network devices 130. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits network devices 130 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that may provide output information from network devices 130 (e.g., a display, a speaker, a user interface, and/or one or more light-emitting diodes (LEDs)). Output component 260 may include a display providing a GUI, such as an interface. Input component 250 and output component 260 may be combined into a single component, such as a touch responsive display, known as a touchscreen.

Communication interface 270 includes a transceiver-like component (e.g., a transceiver and/or a separate receiver and transmitter) that enables network devices 130 to communicate with other devices, such as via a wired connection, a wireless connection, or a combination of wired and wireless connections. Communication interface 270 may permit network devices 130 to receive information from another device and/or provide information to another device. Communication interface 270 may include one or more RFFEs (radio frequency front ends) with antennae circuitry and RF (radio frequency) filters which may be variable power and/or purpose adapted for various communication frequencies, standards, links, and distances. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of network devices 130. Battery module 290 may supply power during field measurements by network devices 130.

The matching algorithm component 280 may assist in forming simulations without a leader by automatically assembling participants into randomized or balanced groups. It may be used to allocate artificial players (bots) as benchmarks, ensuring a competitive and educational environment. By leveraging real-time market data, the matching algorithm may dynamically update simulation rankings, track aggregated distribution weighting performance, and validate rule compliance, making the simulation experience seamless and accurate for all users.

Network devices 130 may perform one or more processes described herein. Network devices 130 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, network devices 130 may include additional components, fewer components, different components, or differently arranged components than those shown in FIG. 2, 200. Additionally, or alternatively, a set of components (e.g., one or more components) of network devices 130 may perform one or more functions described as being performed by another set of components of network devices 130.

FIG. 2 is a diagram of components of network devices 130, according to an example of the present disclosure. Network devices 130 may include a bus 210, a processor 220, a memory 230, a storage component 240, an input component 250, an output component 260, a communication interface 270, and battery module 290.

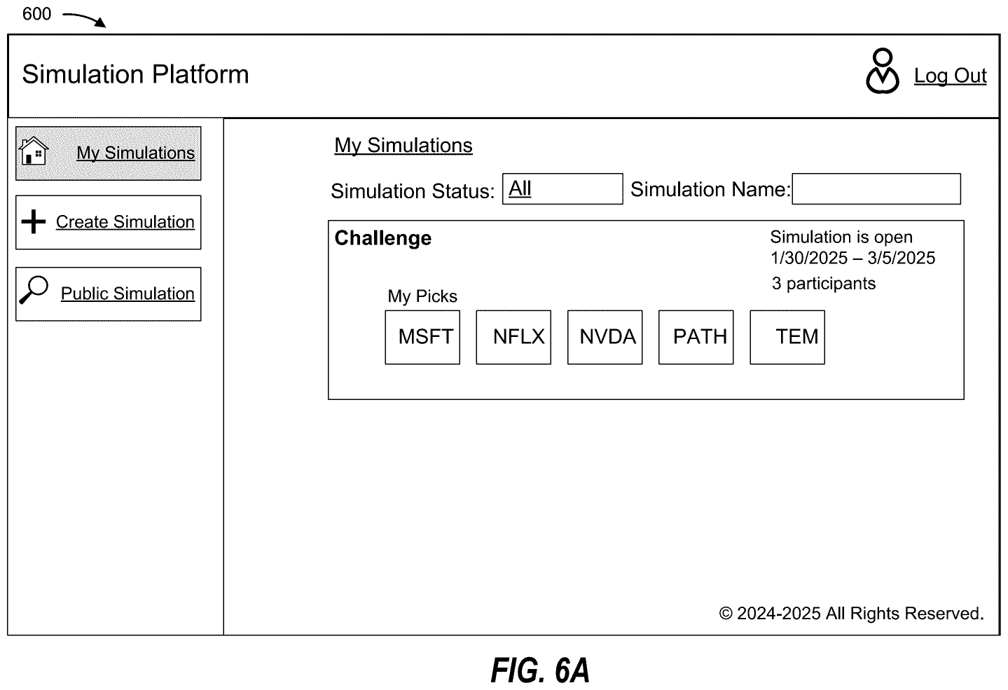

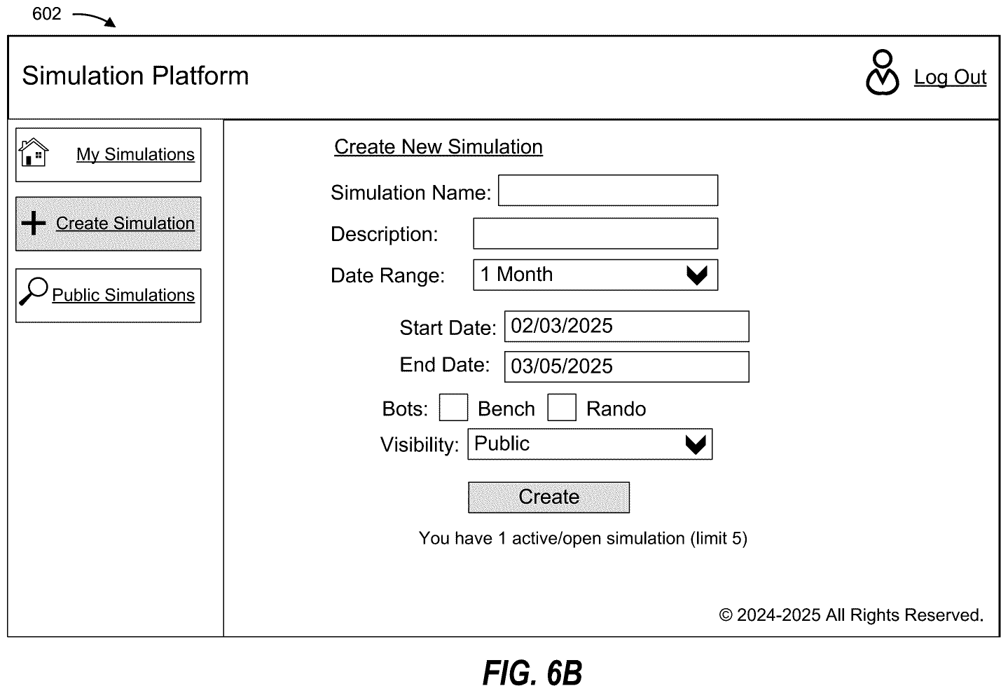

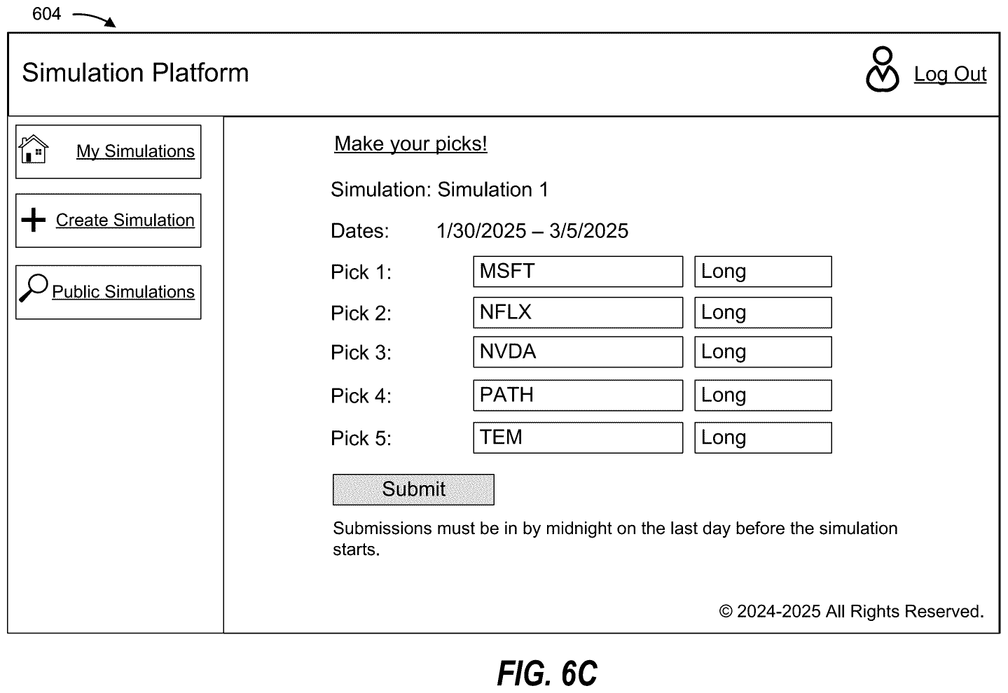

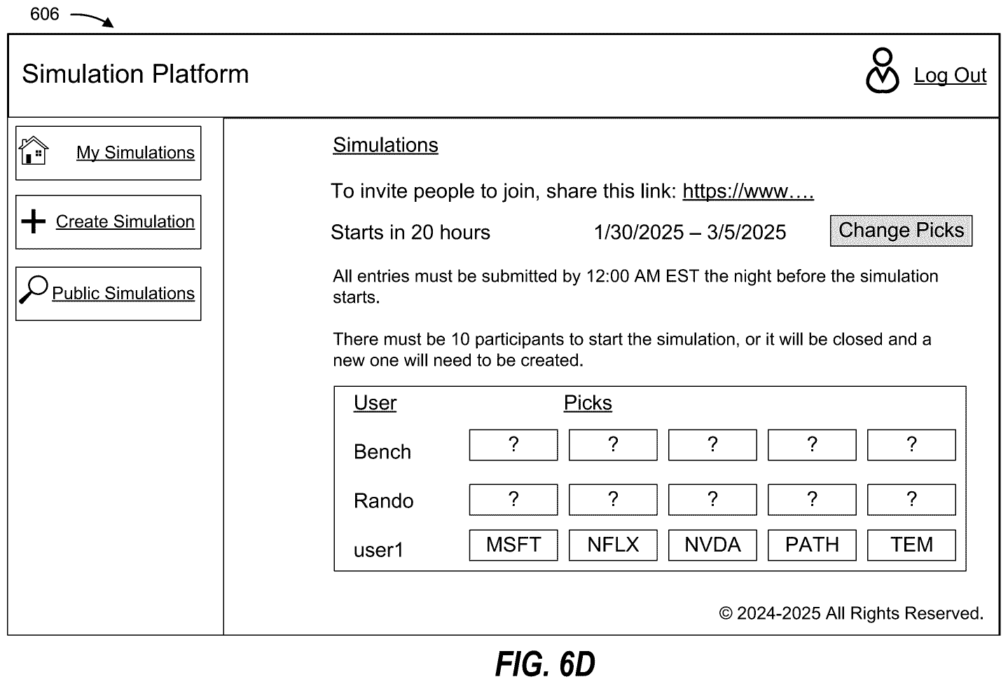

Bus 210 includes a component that permits communication among the components of Network devices 130. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. According to an example, processor 220 is processor 220 of FIG. 6. Memory 230 may include one or more memories such as a random-access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of Network devices 130. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits network devices 130 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that may provide output information from network devices 130 (e.g., a display, a speaker, a user interface, and/or one or more light-emitting diodes (LEDs)). Output component 260 may include a display providing a GUI, such as an interface. Input component 250 and output component 260 may be combined into a single component, such as a touch responsive display, known as a touchscreen.

Communication interface 270 includes a transceiver-like component (e.g., a transceiver and/or a separate receiver and transmitter) that enables network devices 130 to communicate with other devices, such as via a wired connection, a wireless connection, or a combination of wired and wireless connections. Communication interface 270 may include one or more short range communication interface modules and medium/long range communication interface modules, and may permit network devices 130 to receive information from another device and/or provide information to another device. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of network devices 130. Battery module 290 permits Network devices 130 to be a portable integrated device for conducting field measurements of propagation delay in a RAN.

Network devices 130 may perform one or more processes described herein. Network devices 130 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Example embodiments user device 150 may include a mobile device/user equipment (UE) 202, a personal computer 204, or a virtual computing system 206 which may include various implementations such as those of 106. Thus, implementations described herein are not limited to any specific combination of hardware circuitry and software.

The number and arrangement of components shown in FIG. 2 are provided as an example. In practice, network devices 130 may include additional components, fewer components, different components, or differently arranged components than those shown in FIG. 2. Additionally, or alternatively, a set of components (e.g., one or more components) of network devices 130 may perform one or more functions described as being performed by another set of components of network devices 130.

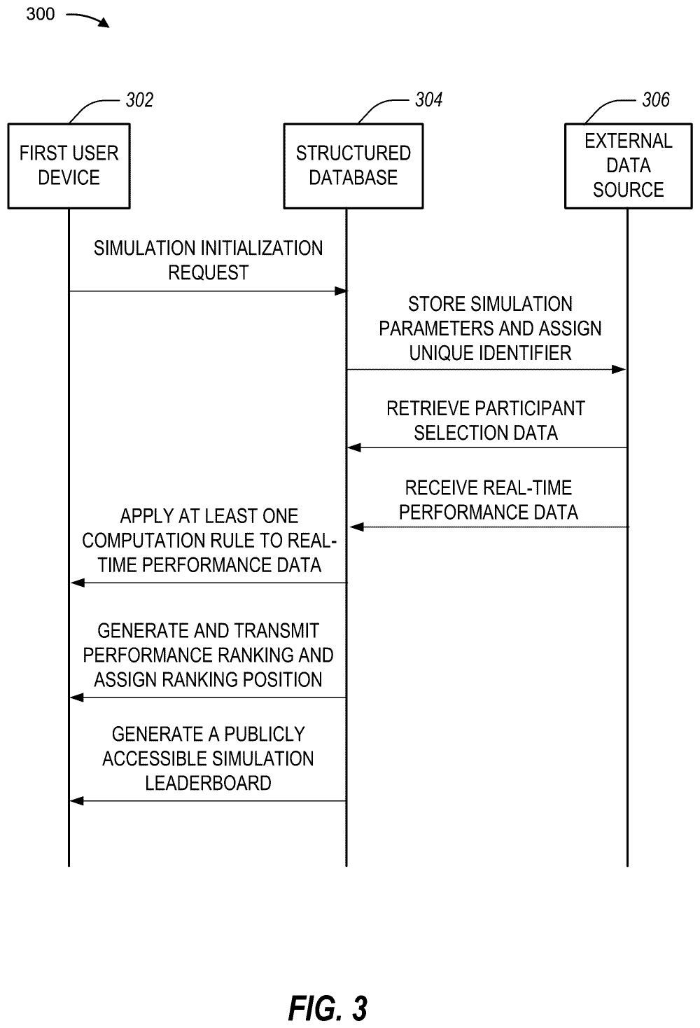

FIG. 3 illustrates a diagram of a simulation platform architecture, according to various examples. Referring to FIG. 3, in certain aspects, simulation platform 300 may be implemented as a combination of hardware and software modules that may receive at least one simulation initialization parameter from a first user device, where the parameter may define a simulation structure including a predefined number of participants, an open selection pool of geography-linked selections, one or more scoring metrics based on real-time data, and a simulation duration. In some aspects, the simulation platform 300 may include an I/O unit 302 that may communicate user commands or parameter submissions from user devices, while the I/O unit 302 may transmit system responses or graphical data to participants. In various aspects, the I/O unit 302 may be formed of physical connectors, network interfaces, or other input pathways that accept signals from multiple device types, including desktop computers, mobile applications, or other network-capable systems.

In several aspects, a processing device 304 may be coupled to the I/O unit 302 to handle system-level computations needed to store or retrieve simulation initialization parameters. Those parameters may be assigned a unique simulation identifier so they may be recognized by additional components of the simulation platform 300. In other aspects, the processing device 304 may operate as a central processing unit that reads instructions from memory 316, computing steps in line with any predefined simulation rule. This processing device 304 may handle multiple parallel tasks, for example verifying participant selection data or applying one or more predefined computation rules to real-time data.

In many aspects, a communication unit 306 may coordinate network-based data exchange, enabling the simulation platform 300 to reach an external data source 324 over the internet or another network. The communication unit 306 may implement wired or wireless data standards, including TCP/IP, cellular protocols, or Wi-Fi, depending on the design choices or constraints of the hosting environment. In certain aspects, the communication unit 306 may request dynamically updating performance indicator values that correspond to at least one geography-linked selection. These performance indicators may be used to assign ranking positions to participant aggregated distribution weightings, especially when the platform is configured to apply at least one predefined computation rule referencing real-time market fluctuations or other time-sensitive data.

In some aspects, the simulation platform 300 may incorporate a decryption unit 308 that may decrypt incoming participant data or secure tokens provided by user devices. This decryption unit 308 may operate in conjunction with user management unit 310 to ensure sensitive participant selection data is validated against at least one predefined simulation rule. In various aspects, the user management unit 310 may govern the process of linking each new selection to a unique simulation identifier in a structured database, thus facilitating a relational mapping of participant aggregated distribution weightings in line with primary claim requirements. The user management unit 310 may store or retrieve user credentials, eligibility information, or other profile data, optionally referencing a table of permissible geographical selections, if the platform is configured to limit or filter certain picks.

In several aspects, a simulation processing unit 312 may perform the logic of applying one or more scoring metrics that are based on real-time data to generate a dynamically updated performance ranking. This functionality may align with the platform's operations to compare multiple participants' returns or compute predicted outcomes if the user has chosen to include historical performance data. In other aspects, the simulation processing unit 312 may coordinate advanced calculations that incorporate weighting participant entries for selection difficulty by referencing the user management unit 310 or external data source 324. Through these processes, the simulation processing unit 312 may determine a ranking position for each participant aggregated distribution weighting according to at least one predefined computation rule.

In many aspects, the platform's memory 316 may be configured to store instructions for orchestrating data retrieval, user management functions, and scoring procedures. This memory 316 may be implemented as volatile or non-volatile media, or a combination thereof, and may hold the necessary programmatic routines for updating a publicly accessible simulation tracking interface. In certain aspects, the memory 316 may be distributed across local hardware, cloud-based storage, or specialized data modules integrated within the same enclosure as the processing device 304. The memory 316 may further store references to a structured database 316, which may contain tables capturing each simulation's assigned identifier, participant selection data, and real-time performance indicators. By storing these items in a structured database 316, the platform may keep track of each participant's aggregated distribution weighting and compute updated standings whenever a relevant new data input arrives.

In some aspects, persistent storage 318 may provide redundancy or archival capabilities for the system, holding snapshots of older simulation parameters or historical performance data that may later be used for generating predictive performance insights. This persistent storage 318 may be physically distinct from the memory 316, or it may be logically partitioned for design flexibility. In various aspects, the persistent storage 318 may allow the platform to retrieve prior simulation data after a completion date, enabling further analysis or replay of results. The use of persistent storage 318 may be beneficial when building new scoring metrics that reference historical participant behaviors or average performance over multiple simulations, thus broadening the potential ways the platform may update or fine-tune any predefined simulation rule.

In several aspects, a scoring engine 320 may form a core module that calculates performance metrics for each participant aggregated distribution weighting. This scoring engine 320 may reference the data that is retrieved by a data retrieval unit 314, which in turn may communicate with external data source 324. The data retrieval unit 314 may request or collect real-time feeds of performance indicator values, historical data sets, or specialized market metrics from external data source 324, enabling the scoring engine 320 to update user standings continuously. In other aspects, the scoring engine 320 may adjust calculations when a participant modifies picks, or when an at least one predefined simulation type imposes a time-based or milestone-based scoring adjustment.

In many aspects, the leaderboard generation unit 322 may display, via a publicly accessible simulation tracking interface, each participant's ranking position based on the continuously updated performance ranking. This leaderboard generation unit 322 may incorporate a visual highlighting technique if the system is configured to differentiate ranking positions or apply one or more ranking thresholds to visually enhance the user interface. In certain aspects, the leaderboard generation unit 322 may produce a unique URL for distributing a limited-time access link to interested parties, thereby reflecting an option for restricting or controlling who may view the live simulation status. The same publicly accessible simulation tracking interface may be supplemented with an interactive chat module to facilitate secure communication among authenticated participants.

In some aspects, the external data source 324 may be an online provider of real-time stock quotes, a financial market aggregator, or a specialized feed tracking microeconomic indicators. This external data source 324 may supply historical performance data, allowing the platform to generate predictive insights or weigh participant difficulty coefficients more precisely. The data source 324 may be configured as a web-based API or any advanced data aggregation pipeline, supporting continuous updates that the simulation platform 300 may use to assign ranking positions or to recalculate scoring metrics if real-time data is changing rapidly. If the system implements an at least one simulation initialization parameter where participants are selecting geography-linked values, the external data source 324 may provide location-specific performance indicators, such as region-based index values or local currency fluctuations.

In various aspects, the platform may operate in synergy with multiple user devices that connect via the communication unit 306. The instructions for receiving at least one simulation initialization parameter may be stored on a non-transitory machine-readable medium within memory 316, so that, upon execution, the processing device 304 may systematically prompt participants for a predefined number of simulation participants, an open selection pool, or a simulation duration. In certain aspects, this approach may guarantee that each user may define a time-based or milestone-based simulation type, or even a performance-based simulation, aligning with the possibility that the at least one simulation initialization parameter includes at least one predefined simulation type from a permissible group of categories.

In several aspects, once the necessary initialization data is stored in the structured database 316, the user management unit 310 may queue the reception of participant selection data. That participant selection data may include a selection of at least one geography-linked selection, referencing stocks, currencies, or other region-specific investment instruments. Before associating that data with the unique simulation identifier, the system may validate it against one or more predefined eligibility criteria, such as verifying a user's prior login or that an open selection pool is still available. During this process, in some aspects, the decryption unit 308 may decode any sensitive user tokens or credentials, thereby ensuring data integrity.

In other aspects, after participant selection data is added to the structured database 316, the simulation processing unit 312 may trigger a retrieval of performance information from external data source 324, verifying that each selection is tracked in real time. The scoring engine 320 may incorporate weighting participant entries if the platform is configured for advanced difficulty scaling, and the leaderboard generation unit 322 may accordingly place participants' aggregated distribution weightings in ascending or descending order on the publicly accessible simulation tracking interface. In many aspects, a dynamic highlighting approach may be used to emphasize top-ranked or underperforming aggregated distribution weightings, ensuring that the simulation leaderboard, which may be updated at intervals or in near real time, visually reflects changes in performance metrics.

In certain aspects, the memory 316 may contain instructions for generating system notifications triggered when a predefined simulation rule is modified, or if an artificial participant entry is introduced. The user management unit 310 may then forward these notifications to relevant user devices, or the communication unit 306 may broadcast them to all active participants. In some aspects, a unique URL may be created for each new or updated simulation leaderboard, further allowing secure or time-limited access. The system may integrate a chat feature, letting authenticated participants discuss strategies or react to ranking shifts in real time, as part of an interactive user environment.

In various aspects, the hardware forming the simulation platform 300 may be constructed with typical computing materials such as plastic or metal enclosures for the processing device 304, integrated circuit boards supporting the memory 316, and network interface chips that constitute the communication unit 306. The software components, including the scoring engine 320 and leaderboard generation unit 322, may be written in languages such as Python, Java, C++, or others, depending on developer preference. The structured database 316 may be realized as a relational SQL database, a NoSQL store, or a combination thereof, as no single architecture is required to accomplish the steps set forth in the claims. In several aspects, the external data source 324 may be supervised by a third-party content provider or a custom data feed aggregator, ensuring that performance indicator values are reliably delivered.

In many aspects, the overall operation of simulation platform 300 may proceed in a loop, repeatedly checking for new real-time data and updating each participant's ranking. The result may be a dynamically changing leaderboard that a user device may display at any moment, facilitating user engagement. If the system includes a feature for retrieving historical performance data, then the data retrieval unit 314 may supply those older metrics or time series to the scoring engine 320 for predictive modeling or advanced scoring algorithms. This supports optional aspects where the platform applies a method of weighting participant entries based on prior volatility patterns or other risk assessments, all of which may constitute further refinements.

In certain aspects, any additional steps that do not appear in the core claims may still be integrated as optional expansions. For example, the system may allow for bot participants that submit randomly selected performance indicator values, or the system may configure a secure communication channel for in-simulation messaging. The memory 316 may likewise support a aggregated distribution weighting revision mechanism permitting participants to alter selections under certain conditions. These features may be realized depending on user preference or business requirements, showing the flexible nature of the platform architecture.

In some aspects, once the simulation duration is reached, the processing device 304 may finalize the performance ranking and store it in persistent storage 318 for potential archiving or historical analysis. This final ranking position may remain accessible through the leaderboard generation unit 322 if the user chooses to keep the simulation publicly visible. Alternatively, the unique URL might be configured to expire automatically, removing casual access once the simulation concludes. Regardless of whether the final results remain public or revert to a private record, the approach ensures a comprehensive, user-friendly process for receiving simulation initialization parameters, managing participant selection data, applying real-time performance rules, and updating a publicly accessible leaderboard in alignment with all relevant claim statements. In some aspects, the processing device 304 referenced above may further incorporate mathematical optimization functions that may dynamically balance memory 316 resources based on expected simulation durations. Such functions may, for example, use integer linear programming or heuristic-based algorithms to allocate bandwidth for data retrieval operations, especially when large amounts of real-time market data flow in from the external data source 324. The system may rely on an internal scheduler that may implement round-robin or priority-based queuing protocols so that all participant aggregated distribution weightings are updated in near-parallel. This scheduling approach may be influenced by a concurrency model derived from standard multiprocessing frameworks, such as POSIX threads, or from lightweight concurrency approaches implemented in a high-level language runtime (e.g., Goroutines if the platform is built in Go, or asynchronous callbacks in Node.js).

In many aspects, each of these concurrency or scheduling models may allow multiple threads or event loops to simultaneously access the structured database 316, while the user management unit 310 may coordinate locking mechanisms or version-control to prevent data inconsistencies. Such locking mechanisms may follow a mutex or spinlock approach if the platform operates in a highly parallel environment, or may strategically implement optimistic concurrency for lower-latency transactions in scenarios where collisions are infrequent. In various aspects, the memory 316 may store a configuration table specifying thresholds for concurrency or permissible thread counts, which may be altered at runtime to adapt to the demands of a busy simulation environment with thousands of participants.

In certain aspects, different material or hardware implementations may be used to create the communication unit 306, reflecting alternative design choices or cost constraints. For example, the communication unit 306 may be embodied as an Ethernet transceiver supporting data rates of 1 Gbps or higher, or as a cellular modem that leverages 5G protocols. In some scenarios, the platform may incorporate specialized antennas or waveguides to handle signals efficiently, ensuring that the dynamic performance indicator values are not delayed or lost during transmission. If an application demands robust connectivity in remote regions, satellite-based communication modules may optionally be integrated, forming an alternative configuration that still retains the core logic for retrieving external data and updating participant rankings.

In various aspects, the data retrieval unit 314 may parse incoming data from external data source 324 using structured formats such as JSON, XML, or CSV, or even binary protocols that may offer higher compression or encryption. The choice of format may depend on the external data source's nature, which may range from public market feeds to private aggregator APIs. The system may implement public-key cryptography to verify the authenticity of any data packets, where a cryptographic signature embedded in the feed ensures that malicious actors do not supply fabricated performance indicators. This verification process may be handled by the decryption unit 308, which may rely on a library of trusted certificates stored in persistent storage 318 to authenticate all incoming real-time data.

In several aspects, the simulation processing unit 312 may harness advanced machine learning (ML) models or classical statistical algorithms to interpret real-time data and project anticipated performance changes for each participant aggregated distribution weighting. For example, the system may integrate a linear regression model or a random forest algorithm that may be trained on historical performance data retrieved by the data retrieval unit 314. By referencing a set of trailing performance windows, the ML model may estimate short-term volatility or expected returns. In some embodiments, as illustrated in FIG. 10, method 1000 may optionally route these estimated volatility figures into a feedback training loop that may calibrate weighting coefficients over time. In that scenario, the simulation processing unit 312 might refine how it calculates final scores based on historical error margins, thereby improving or adjusting the ranking calculations automatically.

In certain aspects, if the system architecture includes an additional feedback training loop (not shown in the present figure), the scoring engine 320 may function to fine-tune internal weighting algorithms for participants who frequently alter their aggregated distribution weightings. A placeholder paragraph for future FIG. X description paragraphs may address these advanced ML-based feedback systems in separate detail. For example, the platform may store intermediate predictive outputs in memory 316, then dynamically update the performance ranking if a user's picks exhibit high variance relative to a baseline index. This dynamic approach may allow the platform to preemptively flag unusual participant selection data or to generate a system notification if the picks violate a threshold.

In many aspects, the user management unit 310 may incorporate an account-based framework where each simulation participant holds an encrypted token. The decryption unit 308 may decode that token upon each login, granting access to the structured database 316 only if eligibility rules are satisfied. This approach may, for example, confirm that each user has not exceeded a maximum number of concurrent simulations. In some aspects, the user management unit 310 may store user-specific configurations, such as whether the user wishes to receive real-time push notifications or scheduled emailed summaries. By toggling these preferences, participants may tailor their experience. If participants indicate they want milestone-based scoring, the system may automatically shift the computation model within the simulation processing unit 312 so that points are assigned only after certain time or performance milestones are reached.

In certain aspects, the leaderboard generation unit 322 may rely on a templating engine written in a language like Python (e.g., Jinja2) or in JavaScript (e.g., React server-side rendering) to format the displayed leaderboard. This may include color-coding top-performing aggregated distribution weightings or graying out entries that have been disqualified by eligibility checks. The dynamic highlighting scheme may rely on CSS transitions or WebGL-based animations. Alternatively, in some embodiments, as illustrated in FIG. 11, a method 1100 may direct the leaderboard generation unit 322 to create regionally customized visuals. For example, if the open selection pool includes geography-linked picks from multiple continents, the interface might cluster them visually on a world map or highlight specific continents where participant selections are concentrated. This further illustrates how the system's capacity for real-time adaptation may be configured for a wide array of use cases.

In several aspects, the external data source 324 might consist not only of a single feed, but of multiple parallel feeds aggregated within a distributed microservices architecture. Each feed might supply data for distinct market sectors (e.g., technology, finance, healthcare) or for different geographies (e.g., Asia-Pacific, North America), thereby offering more granularity in the performance indicator values. If a participant selects a combination of picks that span multiple feeds, the scoring engine 320 may unify data from all relevant feeds to present the final ranking. Such unification might occur in near-real time, ensuring that short-lived market fluctuations are captured. This process may be further expanded if the system is integrated with a separate method to retrieve niche data, for example, environmental or sustainability indicators for certain stocks.

In other aspects, materials used to construct the hardware portion of simulation platform 300 may range from standard aluminum chassis for server-grade racks to specialized rugged enclosures if the platform is deployed in harsh industrial settings. Each hardware component may be rated for temperature, humidity, and electromagnetic interference resilience. In the context of thermal management, for example, the processing device 304 may be mounted with either passive heatsinks or liquid-cooling loops that may dissipate heat efficiently during intensive scoring computations. The longevity of these hardware elements may be crucial in continuous operation scenarios, where the platform remains online for extended durations to deliver prompt real-time updates.

In certain aspects, the creation of an artificial participant entry may require only minimal code changes within the user management unit 310. An algorithmic routine might randomly select from a curated list of geography-linked picks, or it may consult a short-term price predictor included in the data retrieval unit 314 to produce simulated aggregated distribution weighting decisions. By introducing artificial participants, testing new scoring metrics, or verifying the system's performance under load becomes feasible. This aspect may be disabled if the system is deployed in a regulated environment with strict compliance requirements.

In many aspects, the platform's archival features in persistent storage 318 may be extended to run regular backups. These backups may be encrypted with an AES-256 or a similarly robust cipher. The decryption unit 308 may coordinate the retrieval of private keys from a secure hardware module if an administrator chooses to restore an older snapshot. By preserving detailed logs across storage layers, the system may permit audit trails that document the entire history of participant additions, rule changes, or ephemeral states of the leaderboard. This auditing capacity may be crucial in regulated industries (e.g., financial trading or e-sports) where traceability is paramount.

In various aspects, the synergy between system memory 316, structured database 316, and persistent storage 318 may allow versioned data retrieval for participants who want to view prior states of the leaderboard or compare historical performance ranking to current results. For example, if a user queries the scoreboard from a previous day, the system may fetch a dated snapshot from persistent storage 318 instead of the live, real-time feed. In some embodiments, as illustrated in FIG. 9, a method 900 may include process 910 that fetches historical data to reconstruct the scoreboard at a specified timestamp and present it to a requesting user device. This level of detail ensures that each step, from initialization to final scoreboard generation, may be tracked and validated.

In some aspects, advanced real-world use cases may involve integration with third-party broker applications or advanced financial models. For example, a professional data analytics firm may deploy the simulation platform 300 to hold educational or promotional simulations. They may define an extended set of one or more predefined simulation types, going beyond time-based or milestone-based frameworks, to include thematic events like “best environmental aggregated distribution weighting” or “lowest volatility strategy.” The system would remain robust under such expansions if it references additional field entries in the structured database 316 and modifies the user interface logic in the leaderboard generation unit 322 so that participants perceive specialized scoring categories.

In certain aspects, if the platform is wholly software-based, the newly introduced modules (e.g., scoring engine 320, data retrieval unit 314, or user management unit 310) may identify participant devices and parse instruction sets to generate leaderboards or data-driven insights. For example, code subroutines might specifically parse user IDs or indexed aggregated distribution weighting picks, then output a refined scoreboard.

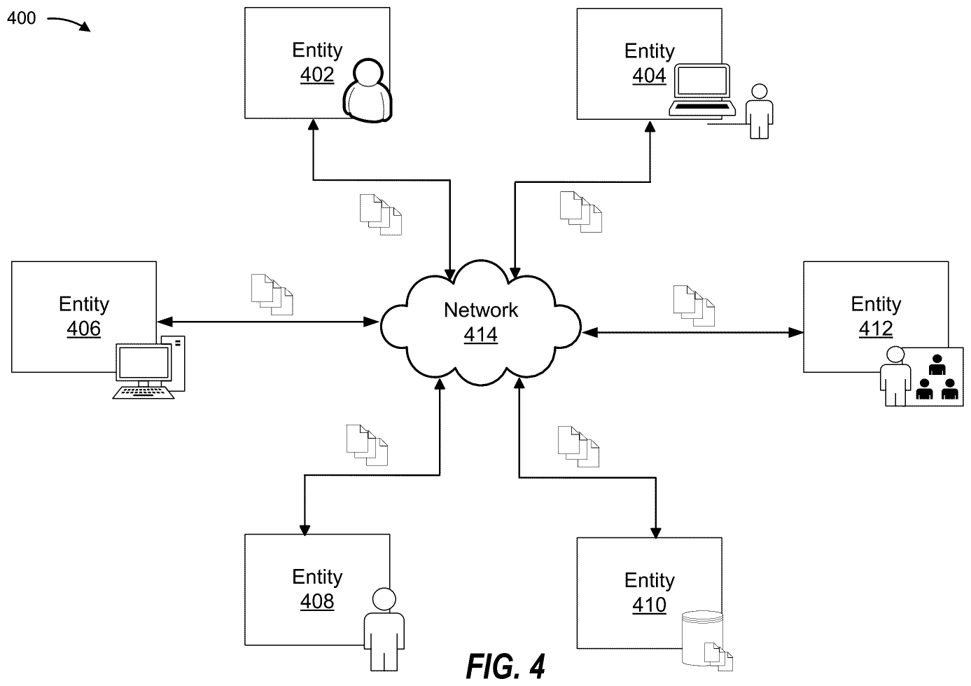

FIG. 4 illustrates a network entity diagram depicting multiple entities communicating via a network, according to various examples. Referring to FIG. 4, which depicts an arrangement 400 in which multiple functional modules may coordinate to receive at least one simulation initialization parameter, store a unique simulation identifier, and dynamically update performance rankings for participant aggregated distribution weightings, there may be a network 314 interconnecting several components. In certain aspects, a user entry system 406 may transmit instructions, participant selection data, or feedback to a participant platform 404, wherein the participant platform 404 may handle processing tasks in accordance with at least one predefined simulation rule. The user entry system 406 may include general-purpose computing hardware, portable devices, or specialized consoles configured to collect textual or graphical input from participants who wish to join or create a simulation. This mechanism may ensure that the system receives at least one simulation initialization parameter that defines a simulation structure with a predefined number of simulation participants, an open selection pool of a plurality of geography-linked selections, one or more scoring metrics based on at least one real-time data input, and a simulation duration.

In some aspects, the participant platform 404 may communicate with a simulation administrator database 412 to store the at least one simulation initialization parameter and to assign a unique simulation identifier for each newly established simulation. Once a unique simulation identifier is created, the participant platform 404 may receive participant selection data associated with the at least one predefined simulation rule. The selection of at least one geography-linked selection may be chosen by one or more participant aggregated distribution weightings that are then mapped inside the simulation administrator database 412 so that each participant's aggregated distribution weighting is properly associated with a specific simulation. This registration may optionally include validating participant selection data against at least one predefined eligibility criterion, such as a maximum number of picks or a restriction on certain geography-linked assets.

In various aspects, the simulation administrator database 412 may hold structured records tying user profiles, open selection pools, and real-time data updates to the unique simulation identifier. The data stored in this database may be updated in near-real-time, allowing the system to obtain the at least one real-time data input from an external data source. This at least one external data source may supply dynamically updating performance indicator values, including current stock market returns, exchange rates, or index performance associated with the user's chosen geography-linked selections. In other aspects, the database may link to the educational data source 402, which may store or provide a variety of historical performance data for generating forecasted insights or predictive modeling, thereby addressing scenarios where computing the at least one real-time data input further comprises retrieving past performance data.

In several aspects, educational data source 402 may be configured to enhance user understanding of the selected instruments. The participant platform 404 may optionally leverage the educational data source 402 to generate suggestions or display context for various geography-linked selections as part of a time-based, performance-based, or milestone-based simulation. If an additional algorithmic module is present, such as an artificial participant entry employing randomly selected performance indicator values, the participant platform 404 may retrieve data from the educational data source 402 in order to simulate more advanced simulation structures. This approach may create scenarios in which new participants measure their performance against a bot competitor within the same digitally maintained environment.

In many aspects, the user entry system 406 may provide an interface for participants to specify or modify their participant selection data. Because one or more scoring metrics may be based on dynamic, real-time data inputs, the user entry system 406 may display these updates at regular intervals or upon request. This system may incorporate placeholders for advanced features such as chat modules or system notifications, enabling the user to receive alerts if a modification of at least one predefined simulation rule occurs in the participant platform 404. This alert may be transmitted through network 314, ensuring that each user device stays synchronized with changes to the simulation.

In certain aspects, external APIs 408 may function as the at least one external data source identified in the claims. The external APIs 408 may include third-party market data services, currency exchange rate feeds, commodity market updates, or other real-time performance sources that supply participant platform 404 with dynamic performance indicator values. The participant platform 404 may apply at least one predefined computation rule to these values in order to determine a performance ranking for each participant aggregated distribution weighting. If the user has selected a performance-based simulation type, for example, the at least one predefined simulation rule may define how weighting participant entries occurs, such that picks with higher risk factor might be assigned special coefficients in computing the final ranking.

In other aspects, the system may assign a ranking position to the one or more participant aggregated distribution weightings by combining the real-time performance indicator values with the participant's geography-linked selections. This ranking position may be updated continuously or periodically in response to the new data input from external APIs 408. Whenever updated results become available, the system may subsequently transmit a new performance ranking to a publicly accessible simulation tracking interface, such as a progress tracker 410. The progress tracker 410 may then display the simulation leaderboard so that authenticated and unauthenticated users alike may view the current results.

In several aspects, the progress tracker 410 may incorporate at least one visual highlighting technique to reflect ranking thresholds or achievement levels. For example, if the top 10% of participant aggregated distribution weightings surpass a certain profit margin, the scoreboard may highlight them in a specific color, reflecting the dynamic approach to visual representation. For a short-lived or time-based simulation, the progress tracker 410 may generate a unique URL configured to provide limited-time access, ensuring that only users with valid credentials or links may view the scoreboard. In some configurations, the system may accept a request from a user entry system 406 to generate a system notification regarding updates or newly posted results, pushing messages out through network 314 as necessary.

In many aspects, these components may operate in synergy to store the simulation initialization parameter in the simulation administrator database 412, retrieve participant selection data, and integrate real-time performance inputs from external APIs 408 or from educational data source 402 for predictive computations. The participant platform 404 may handle orchestrating each step, including receiving user picks, verifying eligibility, obtaining real-time metrics, and updating the progress tracker 410. If specialized data analytics is included, the platform may retrieve past data from the educational data source 402 to refine predictions or otherwise review historical performance. This optional predictive modeling is supported by the approach in which retrieving historical performance data may generate predictive performance insights.

In certain aspects, the flow of network 314 data transmissions may employ standard or proprietary protocols to maintain security and efficiency. A high level of encryption may be optionally applied, if a decryption module or other protective measure is used by the participant platform 404 or the simulation administrator database 412, ensuring that personal or financial details are only accessed by authorized users. Should the system require a chat module or other secure communication channel, the user entry system 406 may rely on network 314 to send such messages to the progress tracker 410, guaranteeing that participants may interact while the performance ranking is being updated in accordance with the real-time data input.

In some aspects, the participant platform 404 might incorporate a logic routine for generating at least one artificial participant entry. This artificial participant entry may involve randomly selected performance indicator values, or it may systematically track a benchmark index for the purpose of comparing user performance to a known reference. The presence of a bot competitor may be beneficial in time-based simulations, performance-based simulations, or milestone-based simulations, each representing at least one predefined simulation type that the at least one simulation initialization parameter may include.

In various aspects, the participant platform 404 or the user entry system 406 may adapt to multiple user devices or interfaces. For example, a participant may specify a new selection for their aggregated distribution weighting through a mobile application, while network 314 relays that updated data to the simulation administrator database 412, linking it to the unique simulation identifier. Soon thereafter, external APIs 408 might deliver updated performance data, prompting the system to re-compute the performance ranking. This flexible architecture allows the described functionality to scale, supporting many participants concurrently.

In several aspects, display features within the progress tracker 410 may include advanced data visualizations or leaderboards that highlight ranking positions according to thresholds defined by the at least one predefined computation rule. The system might adapt the color scheme or layout of the interface if certain thresholds are surpassed, thereby satisfying the requirement for dynamically adjusting a visual representation of the leaderboard. In certain embodiments, a real-time scoreboard might highlight the top three aggregated distribution weightings or mark participants who have newly passed a milestone. Such adaptive rendering may encourage ongoing engagement among participants, especially if the system is integrated with social channels via the user entry system 406.

In many aspects, the simulation administrator database 412 may incorporate a relational structure in which each unique simulation identifier is linked to an arbitrary number of participant aggregated distribution weightings. This layout may be supplemented by an index that references user IDs, especially if there is a step that specifically involves validating the participant selection data. If an eligibility check fails, the user entry system 406 might generate an error prompt or system notification relayed through network 314 to inform the participant that certain constraints were not met. These constraints may vary from geography-based limitations to a requirement that the user does not exceed a maximum number of picks.

In certain aspects, additional logic may be layered onto the participant platform 404 so that modifications to at least one predefined simulation rule prompt a system notification. This system notification may be dispatched to relevant user devices via the user entry system 406 or the progress tracker 410. For example, if a simulation administrator decides to introduce weighting participant entries based on difficulty mid-simulation, the system might update the at least one predefined computation rule, recalculate the performance ranking, and transmit a notification to all participants. The presence of a publicly accessible interface ensures that no user is left unaware of the changes.

In some aspects, the educational data source 402 may rely on robust database clusters having multi-terabyte capacity to store wide-ranging historical performance records, possibly from local or global markets. The participant platform 404 may query these records to glean patterns for future simulations or to generate real-time interpretive data. Alternatively, some participants may prefer simpler usage where only the external APIs 408 feed immediate performance indicators without any historical context, highlighting that the system may accommodate multiple computational intensities.

In various aspects, the entire arrangement 400 shown in FIG. 4 demonstrates how a system may enable participants to engage in simulations that align with the claims describing at least one non-transitory machine-readable medium or a method configured to execute these operations. Through the synergy of user entry system 406, participant platform 404, simulation administrator database 412, external APIs 408, educational data source 402, and the progress tracker 410, the system may seamlessly handle creating a simulation, storing parameters, receiving participant selection data, obtaining real-time performance indicators, applying computation rules, and rendering a dynamic public leaderboard.

In other aspects, advanced optimization or load-balancing routines might manage high-traffic scenarios, especially if thousands of users simultaneously update selection data or if external APIs 408 deliver rapid fluctuations in market values. This approach may become particularly relevant for time-based simulations, which incorporate shorter durations and more frequent ranking updates. Optionally, the network 314 may employ distributed ledger technologies for storing final results, although simpler relational database implementations remain feasible in a wide range of embodiments.

In several aspects, the arrangement 400 is not limited to a single platform or hardware configuration. Instead, the system may function across various hardware devices, operating systems, and data channels, as the technology is designed to remain flexible. Each block in FIG. 4, including the participant platform 404, user entry system 406, external APIs 408, progress tracker 410, educational data source 402, and simulation administrator database 412, may run on shared or separate servers. Different security layers and encryption schemas may be introduced to address data sensitivity or local privacy regulations in whichever region the system is deployed.

In many aspects, the generation of a publicly accessible simulation tracking interface may include automated methods for distributing a unique URL to prospective participants or viewers, enabling them to observe the dynamic performance ranking. Such a URL may grant limited-time access, after which it expires or reverts to a restricted state. This approach may satisfy those claims involving the ability to share the simulation leaderboard with an external audience, while still limiting indefinite publication of sensitive financial data.

In certain aspects, network 314 transmissions may incorporate robust error-handling or caching logic to guarantee that no participant data is lost during temporary network downtime. The simulation administrator database 412 might store snapshots of each participant's aggregated distribution weighting data at regular intervals, ensuring that each simulation's state may be rebuilt if an outage occurs. Such resiliency measures may facilitate large-scale adoption of the platform, supporting optional expansions that integrate new forms of real-time data or advanced machine learning modules for aggregated distribution weighting recommendations.

In some aspects, an optional system notification might be triggered when the user-defined starting date for a simulation is reached, automatically obtaining the real-time data from external APIs 408 or from the educational data source 402 to calculate each participant's initial ranking. This initial ranking may appear in the publicly accessible tracking interface displayed by the progress tracker 410, thereby allowing participants to witness the dynamic changes in performance metrics as soon as the simulation goes live. If the participant platform 404 detects fewer than the predefined number of participants required, it may close or reschedule the simulation, optionally delivering a message to the user entry system 406 explaining that the simulation cannot proceed as specified.

In various aspects, these collaborative and interdependent blocks may all feed data to one another through network 314, maintaining a continuous loop of retrieving real-time data, applying the at least one predefined computation rule, and updating each participant's assigned ranking position. By analyzing the figure as a whole, a person skilled in the art may develop or deploy a variety of simulation-based applications focusing on geography-linked selections, real-time performance updates, or selective weighting of aggregated distribution weightings for advanced ranking algorithms.

In other aspects, the arrangement 400 may incorporate a modular design in which any block, such as the educational data source 402, may be replaced or supplemented by an alternative data repository. Similar replacements for the external APIs 408 might allow specialized data feeds, such as micro-market trades, cryptocurrency updates, or corporate earnings statements. This broad capacity for expansion may support numerous claim embodiments describing time-based simulations, performance-based simulations, milestone-based simulations, or variations thereof, all governed by the flexible approach to storing parameters, validating participant data, and computing dynamic rankings.

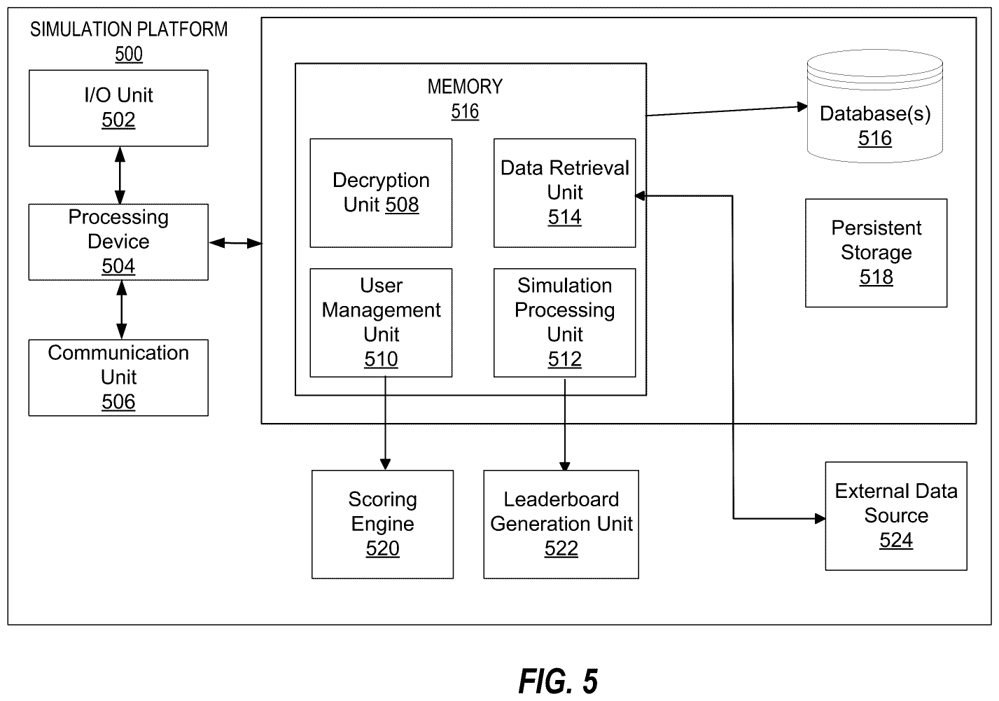

FIG. 5 illustrates a simulation platform architecture, according to various examples. Referring to FIG. 5, which depicts method flow 500, in certain aspects, a first user device 502 may transmit at least one simulation initialization parameter to a structured database 504. This simulation initialization parameter may define a simulation structure that includes a predefined number of simulation participants, an open selection pool of a plurality of geography-linked selections, one or more scoring metrics based on at least one real-time data input, and a simulation duration. In many aspects, this simulation initialization parameter may appear on first user device 502 in the form of a graphical user interface or an automated input routine, potentially receiving user-created data or automatically supplied data specifying how long a simulation may last, how many participants may be allowed to join, and which categories of selections or stocks may be included.

In some aspects, structured database 504 may store these simulation parameters along with a unique simulation identifier. For example, once the at least one simulation initialization parameter is received, the instructions residing on a processor associated with structured database 504 may attach an alphanumeric code or other unique referencing scheme. In various aspects, this assignment of a unique simulation identifier may enable the system to track multiple concurrent simulations, each identified by a parameter set that includes or may include details about whether the simulation is time-based, performance-based, or milestone-based (as an optional feature consistent with certain aspects of a predefined simulation type). The data stored within structured database 504 may be maintained in a memory that includes instructions for robust data validation, retrieval, and future referencing of each parameter.

In other aspects, structured database 504 may then receive participant selection data relating to each user's chosen set of one or more geography-linked selections. This participant selection data may include information about which individual stocks, indexes, or assets are being selected by a participant aggregated distribution weighting. The participant selection data may correspond to at least one predefined simulation rule, ensuring, for example, that participants do not exceed a maximum number of picks or that they adhere to a requirement to submit choices prior to a given start date. In certain aspects, this system may further validate the participant selection data to ensure compliance with any predefined eligibility criterion. For example, a user might be restricted from selecting certain highly illiquid assets or from entering more than one aggregated distribution weighting in the same simulation. This validation step may be performed automatically upon submission of participant selection data from first user device 502.

In several aspects, after the participant selection data is validated, structured database 504 may associate that data with the unique simulation identifier, thereby generating a relational mapping of participant aggregated distribution weightings. The relational mapping may store links between each participant's chosen geography-linked selection set and the relevant simulation parameters. In many aspects, the instructions in structured database 504 may facilitate quick lookups, ensuring that a query about a specific simulation or participant triggers immediate retrieval of the relevant data for computation or display. This relational mapping may support advanced logic, such as weighting more difficult selections using a scoring coefficient in certain optional configurations.

In some aspects, external data source 506 may provide the at least one real-time data input referenced by the claims. This external data source 506 may be an online stock feed, a cryptocurrency exchange, or a data aggregator for commodity indices. The real-time data inputs may incorporate dynamically updating performance indicator values that reflect how each geography-linked selection is performing at any given time. In certain aspects, external data source 506 might supply historical performance data, allowing structured database 504 (or an associated processing server) to compute predictive performance insights if an optional rule is specified to retrieve historical data for advanced analytics. These real-time metrics may be retrieved at periodic intervals or upon demand.

In various aspects, structured database 504 may then apply at least one predefined computation rule to the real-time performance data to generate a performance ranking for one or more participant aggregated distribution weightings. The predefined computation rule may, for example, calculate returns, risk metrics, or performance deltas between each user's picks and relevant benchmarks. In some aspects, the instructions may account for weighting participant entries if certain unusual asset classes or risk profiles are chosen. This weighting approach may correspond to an optional expansion of the original ranking mechanism to reflect a more sophisticated scoring environment. The system may, but need not, rely on the same or separate servers to apply these computation rules; the scope is broad enough that either structured database 504 or an external server operating in conjunction with that database may perform the calculations.

In other aspects, once the performance ranking is generated, structured database 504 may assign a ranking position to each participant aggregated distribution weighting based on the newly calculated performance. For example, if a participant's picks have generated higher returns than others for a given time interval, the system may place that participant in the top position. In many aspects, the updates to ranking positions may occur throughout the simulation duration whenever newly fetched real-time data arrives from external data source 506. This dynamic update process may be especially relevant in time-based simulations that continue over a fixed day range or milestone-based simulations that require a threshold metric (like crossing certain performance benchmarks) to trigger recalculations.

In certain aspects, structured database 504 may then generate a publicly accessible simulation tracking interface, which may include a simulation leaderboard. This simulation leaderboard may be provided via a web page, a specialized application, or a publicly shared link. The system may update it continuously or periodically to reflect participants' current ranking positions. In some aspects, a unique URL might be assigned for the leaderboard, enabling limited-time access or restricting viewers to a specified window of time. This feature may be used if the simulation parameters specify that only participants may see the rankings until the simulation concludes, or the system may create an interactive chat module to accompany the leaderboard in another optional extension. If a real-time chat module is included, participants may discuss strategies and question data fluctuations, all within a secure environment as needed.

In several aspects, if any modifications to a predefined simulation rule occur, for example, if a simulation administrator decides to adjust the maximum number of participants or changes how performance-based scoring is weighted, the system may generate a system notification that one or more user devices receive. This approach may help inform participants that the rules have changed, and new compliance or new data structures may need to be established moving forward. Depending on the optional features selected, the structure for these notifications may be a push alert, an email, or an in-application prompt.

In many aspects, the software modules enabling all these instructions may be implemented via at least one non-transitory machine-readable medium. The instructions on that medium, when executed, may handle the entire data flow shown in the figure. This approach may include receiving at least one simulation initialization parameter from first user device 502, storing that parameter in structured database 504 alongside a unique simulation identifier, and retrieving participant selection data for association with the same identifier. In some aspects, this backend environment might employ memory that is physically or logically separate from structured database 504, though the figure indicates that the centralized storage environment might hold the critical parameters. The external data source 506 may be physically distributed or recognized as a remote service that offers an API specifically for real-time performance indicator values.

In certain aspects, the instructions for the fundamental steps from receiving participant selection data to generating a ranking position align directly with the method flow described in the figure. The instructions identify each user's picks, fetch relevant real-time data from external data source 506, apply computational logic that may incorporate historical or dynamic weighting, and produce an updated ranking. The system may subsequently distribute the ranking to relevant user devices. In some aspects, the distribution to user devices might include the generation of a high-level scoreboard or a more detailed scoreboard with color-coded or visually highlighted performance metrics. If desired, a real-time scoreboard may be displayed that modifies the background color for participants who surpass certain ranking thresholds, paralleling an optional aspect of visually highlighting the leaderboard based on rank.

In various aspects, the instructions may generate at least one artificial participant entry that uses randomly selected performance indicator values or algorithmic picks. This artificial participant entry may be realized within structured database 504 as if it were another aggregated distribution weighting, with the external data source 506 feeding random or pseudo-random performance updates. The system may apply the same predefined computation rule for these artificial participants so that they appear in the leaderboard among real human participants, potentially serving as a control or demonstration of baseline performance.

In several aspects, the dynamic reevaluation of participant standings may prevent any static snapshot from dominating the entire simulation. For example, the real-time data from external data source 506 might fluctuate minute-to-minute or on a daily basis, prompting structured database 504 to continuously recalculate the performance ranking. In many aspects, the first user device 502 (or any authorized device) may retrieve these updates through a web service call or another transmission protocol, ensuring that the public leaderboard remains accurate at all times. This flow might incorporate recommended security measures or encryption to protect user credentials and ensure the data is only accessible to authorized participants, or to a broader public if the simulation has been deemed public by the chosen initialization parameters.

In some aspects, the instructions might support further expansions to how the system obtains or processes real-time data-such as linking multiple external data sources 506 that each supply unique market information. The scoreboard or other computations might weigh each feed differently or cross-reference multiple feeds to produce an aggregated performance indicator. This approach may cater to advanced simulations that rely on multi-national stock indices or specialized commodity data. Similarly, the instructions might enable time-based constraints, requiring user picks to be locked in prior to the start date, or might permit mid-simulation changes if an optional rule is defined for partial updates. Once again, each such rule might be stored in structured database 504 with a mapping to the relevant unique simulation identifier.

In other aspects, the figure's flow may help unify how the user creates and enters simulations, how real-time data is fetched, and how results may be displayed or shared with public or private audiences. Because the figure showcases only high-level steps, the system may incorporate sub-processes that push notifications to participants when certain thresholds are crossed or deploy additional analytics that highlight which participants are trending upward.

In several aspects, each component depicted in FIG. 5 may be realized in hardware, software, or a combination of both. First user device 502 may be a mobile phone, a tablet, or a personal computer. External data source 506 may be any cloud-based data feed or aggregator with recognized connectivity protocols (e.g., HTTP REST, WebSocket, or similar). Structured database 504 may be a SQL-based server, a NoSQL store, or a distributed data management system. The method flow 500 remains sufficiently flexible and may be applied to various scenarios without altering these steps' fundamental logic.

In many aspects, this architecture may thereby offer a way for end users to interact with a system that is receiving at least one simulation initialization parameter, storing and validating participant selection data, and carrying out dynamic scoring computations using real-time data. The final output of the system may generate a leaderboard that may be accessed by any permitted device, fulfilling the requirement of a publicly accessible simulation tracking interface. This high-level flow in FIG. 5 thus may underline how the disclosed system or method allows participants to create simulations, track their real-time aggregated distribution weighting performance, and engage with an evolving ranking environment that may incorporate numerous optional features highlighted in the claims.

FIGS. 6A-6D illustrate a graphical user interface for a simulation platform, according to various examples. In certain aspects, a user interface referred to herein as simulation platform interface 600 may present an arrangement of interactive elements that facilitate receiving at least one simulation initialization parameter from a first user device. This interface may define a simulation structure that includes a predefined number of participants, an open selection pool of various geography-linked selections, one or more scoring metrics grounded in at least one real-time data input, and a designated simulation duration. In many aspects, a side navigation panel may be displayed along the left side of simulation platform interface 600, providing selections labeled “My Simulations,” “Create Simulation,” and “Public Simulations.” Each label may correspond to a distinct navigation path whereby a user may input parameters regarding the total participants, a timeline for the simulation, and optional features such as weighting participant entries based on difficulty. These navigation elements may be implemented in diverse software frameworks, potentially using HTML, JavaScript, or another technology that supports dynamic content updates.

In some aspects, the display region toward the right side or center of simulation platform interface 600 may include fields for “Simulation Status” and “Simulation Name,” enabling a user to query or filter simulations stored in a structured database that assigns a unique simulation identifier to each instance. The structured database may be a SQL-based system, a NoSQL information store, or any other storage mechanism that accommodates high-availability reads, concurrency considerations, and real-time updates. In various aspects, when a user employs “Simulation Status: All,” the interface may retrieve multiple simulations from this structured database by referencing their respective unique simulation identifiers, thus associating a variety of participant aggregated distribution weightings with each identified simulation. Such retrieval may correspond to a method step of applying instructions that cause a processing circuitry to retrieve stored data for dynamic display.

In several aspects, the upper portion of simulation platform interface 600 may include an account management mechanism or log-out control (e.g., “Log Out”). This control may be associated with a secure user authentication process that manages slices of user sessions and ensures that only authenticated participants may submit new parameters to the system. In certain aspects, the instructions stored in a non-transitory machine-readable medium may cause the processing circuitry to validate participant selection data gathered from each user device before associating it with a unique simulation identifier, thus satisfying the requirement noted in some dependent claims regarding eligibility criteria. A variety of different validations may be performed, including but not limited to verifying that each participant's open selection pool corresponds to allowed geography-linked selections.

In other aspects, simulation platform interface 600 may further display a “Simulation” section that includes textual details about an existing or newly created simulation. For example, there may be a label indicating that a specific “Simulation is open Jan. 30, 2025-Mar. 5, 2025 and has 3 participants.” Such textual details may reflect the at least one simulation initialization parameter previously stored in the structured database. In certain aspects, if a user chooses to create a new simulation, the system may store the at least one simulation initialization parameter, define a unique simulation identifier, and optionally retrieve historical performance data from an external data source to implement predictive insights on how each participant aggregated distribution weighting might behave. In many aspects, the platform may store these data points in a cloud-based repository or within on-premise hardware. Materials, including the underlying software modules and data structures, may be designed for high modularity so that each array or table storing participant selection data may be readily updated when the real-time data input changes.

In several aspects, the “My Picks” region, as shown within the interface, may display buttons or labels such as “CIPO,” “CNIPA,” “JPO,” “KIPO,” and “USPTO.” These labels may be interpreted as geography-linked selections referencing particular regional indices or stocks. Each selection may be captured as participant selection data, leveraging an open selection pool that the user may customize or filter based on predefined simulation rules. In some aspects, receiving these participant picks may involve the step of associating the chosen stocks or indices with the unique simulation identifier so that the structured database may later apply at least one predefined computation rule to compute an overall performance ranking. Such a ranking may be updated dynamically through frequent queries to an external data source that may provide new performance indicator values with each data refresh interval.

In certain aspects, the external data source that supplies real-time performance indicator values may be a financial API or a specialized marketplace feed that publishes geographical market metrics. The system may monitor these inputs and recalculate each participant's returns or scores accordingly. This aligns with the claims directing that the medium include instructions to obtain the at least one real-time data input from a recognized source and to apply at least one predefined computation rule for ranking. In many aspects, the system may incorporate weighting factors to account for selection difficulty, thereby implementing the concept of weighting participant entries and capturing an advanced scenario where certain geography-linked picks are more volatile than others. Such weighting may occur each time a new performance indicator value arrives, ensuring that the ranking system remains fair across potentially varied selection pools.

In other aspects, the dynamic ranking results may be shown in a publicly accessible interface, typically realized as a leaderboard. This leaderboard may appear as an optional page or modal accessible from simulation platform interface 600. Although not explicitly rendered in FIG. 6A, references to a publicly accessible simulation leaderboard may be inferred from the user's ability to select or view simulations. Once the real-time data updates are processed, the system may respond by systematically assigning a ranking position to the participant aggregated distribution weightings that are found to outperform others based on the last known performance metrics. In some aspects, the leaderboard may be formatted with color-coding or highlighting to satisfy the claim element of using at least one visual highlighting technique, and it may optionally adjust the visuals at certain ranking thresholds.

In several aspects, each simulation may remain open for new participants until a predefined start date, at which point further participant selection data submissions may be prevented to preserve fairness. The “Simulation is open” label shown in FIG. 6A may illustrate that new user devices are welcome to supply picks up until the specified date, conforming to the requirement that the system receive participant selection data and store or validate it before finalizing. If fewer participants join than the predefined simulation rules require, the simulation might be canceled or repurposed. Conversely, if more participants join, the structured database may merely scale to accommodate them, further illustrating the system's capacity for handling indefinite expansions of participant data.

In many aspects, each user device interaction with simulation platform interface 600 may be orchestrated by a processing device and memory resources that store the instructions for ingesting, validating, and displaying simulation-related information. The instructions may cover additional functionalities, such as generating a system notification whenever a user modifies a predefined simulation rule (for example, changing the maximum picks allowed or toggling a milestone-based format). This system notification may propagate through a communication channel to multiple user devices, preserving transparency and encouraging real-time collaboration.

In some aspects, the side menu's “Public Simulations” button may direct the user to a page containing simulations flagged as publicly available, thus generating a publicly accessible simulation tracking interface for anyone who obtains the relevant unique URL. This optional approach may fulfill a scenario described in the claims in which the unique URL for a leaderboard is configured to allow limited-time access or to expire after the conclusion of the simulation. Meanwhile, for private simulations, the system may generate token-based access links that store ephemeral session details, ensuring that only authorized participants may view or manipulate the performance ranking.

In various aspects, the stored code base guiding these operations may be written in a wide range of programming languages, such as Python, Java, or C++, allowing the platform to integrate external data source queries and maintain an up-to-date scoreboard. The underlying user interface shown in simulation platform interface 600 may incorporate a reactive web framework, for example React.js or Vue.js, so that front-end components may refresh the displayed picks, statuses, or participant counts without requiring full-page reloads. In certain aspects, real-time communication protocols such as WebSocket or server-sent events may be employed to push live updates to connected participants, further enhancing the publicly accessible simulation tracking interface.

In several aspects, the picks labeled “CIPO,” “CNIPA,” “JPO,” “KIPO,” and “USPTO” shown in FIG. 6A may be illustrative of a scenario where users choose from multiple patent office indexes or hypothetical stock tickers that track regional economic performance. Each labeled pick may represent a portion of the open selection pool described in the claims, allowing participants to craft their optimized or experimental aggregated distribution weightings. If a user's selection does not pass certain eligibility checks, the system may display an error message or prompt them to revise their choices, thereby implementing the concept of validating participant selection data. Such checks may include verifying that the picks do not exceed an allowed maximum number, are not restricted or obsolete instruments, or comply with a designated difficulty threshold.

In other aspects, user experience elements may facilitate the user's ability to name simulations or attach textual descriptors in the “Simulation Name” input, which may record user-specific notes or thematically identify the simulation. This approach may align with the additional claim that the at least one simulation initialization parameter may incorporate a time-based, performance-based, or milestone-based arrangement. A time-based simulation might conclude on the date shown (Mar. 5, 2025), whereas a milestone-based simulation may end sooner if a particular performance threshold is reached. The system architecture supporting these variations may rely on scheduling tasks that evaluate the next event deadline or data-driven triggers that detect an applicable milestone in the real-time updates.

In certain aspects, once the simulation has begun, the system may generate at least one artificial participant entry by selecting randomly generated performance indicator values. Such a feature may be an optional enhancement, granting novices a comparative benchmark or simulating additional simulation within the same structure. The artificial participant may appear in the “My Simulations” list or under “Public Simulations” if the simulation is publicly accessible. The stored instructions may similarly handle a weighting factor for the artificial participant so that the final performance ranking fairly reflects each participant's skill or speculation. These aspects remain closely aligned with the dependent claims specifying artificial participant entries or different weighting coefficients.

In many aspects, the displayed user interface region showing “3 participants” may be updated whenever a new user account, or a bot user, associates its selections with the unique simulation identifier in the structured database. The real-time data input from an external source may then be fetched at intervals, and the at least one predefined computation rule may be applied to recalculate the performance ranking. This cycle of storing data, retrieving data, and updating rankings underscores the multifaceted nature of the system, demonstrating how the final score or performance is linked to continuously changing market conditions. In certain aspects, a final ranking position may be displayed as part of a “winners” panel or summary, ensuring a transparent and consistent approach when the simulation period ends.

In several aspects, once the updated performance ranking is determined, the system may generate a leaderboard. That leaderboard may be publicly accessible, possibly triggered by a user selecting “Public Simulations” or by the system automatically revealing final standings at the designated end date. This feature may incorporate visual highlighting techniques to differentiate leading aggregated distribution weightings from mid-tier or trailing aggregated distribution weightings, aligning with the claim that calls for dynamically adjusting the visual representation of the leaderboard based on one or more ranking thresholds.

In other aspects, modifications to any predefined simulation rule-like changing the maximum permitted picks or revising the scoring metric-may prompt the system to generate a system notification. This notification may appear in a pop-up message on the user's device or be sent via email, ensuring that relevant participants are alerted to changes that might affect the final outcome. The logic for such notifications may be structured so that any update to the computation rule or the real-time data feed triggers an automated message. If the rule adjustment is disallowed, the user may be prompted to revert it, preventing conflicts within the structured database.

In certain aspects, these activities collectively show how simulation platform interface 600 may be integrated into a broader method for receiving initialization parameters, validating participant data, and dynamically updating real-time rankings. Each labeled zone in FIG. 6A may correspond to particular operations spelled out in the claims, while supporting multiple potential embodiments, including milestone-based or performance-based scoring, variable weighting coefficients, or partial automation with artificial participants. The materials used to implement simulation platform interface 600 may comprise a networked environment connecting computing devices, memory modules storing instructions, user interface design features, and security frameworks that encrypt or protect sensitive participant data.

In many aspects, this interface may serve as a navigational gateway. Users may create or join simulations, pick geography-linked selections, or observe their evolving standings according to the external data feed. The knowledge gleaned from historical market data may likewise be used by participants to refine their picks, thus tying into the claim that computing real-time data may further comprise retrieving historical performance data for predictive insights. In certain aspects, these optional analytics may be displayed in pop-up tooltips or side panels, granting an additional dimension of strategic planning.

In some aspects, all of these technical elements revolve around the principle that the system receives at least one simulation initialization parameter, associates participant selection data with a unique simulation identifier, obtains real-time (and possibly historical) performance inputs, applies a predefined computation rule, and assigns each participant a ranking position that is updated in a leaderboard. FIG. 6A may illustrate the user's perspective of these processes, notably how participants may see an open simulation with start and end dates, manage their picks, and track the total number of participants. In certain aspects, the publicly accessible nature of the interface is a key differentiator, allowing outside viewers or additional entrants to observe ranking updates in near real-time.

In various aspects, the structure, logic, and user interface code implementing simulation platform interface 600 may be stored in a non-transitory machine-readable medium, providing instructions for the processing circuitry to execute all necessary operations in a secure, accurate, and traceable manner. These operations may be performed on commodity hardware or specialized servers, and they may be distributed across multiple data centers or localized in a single node, depending on performance and reliability requirements. As new participants register or new real-time data feeds become available, the system may adapt fluidly, guaranteeing that the claims are adequately served by the disclosed arrangement. In certain aspects, FIG. 6B may illustrate a simulation platform interface 602 that may receive at least one simulation initialization parameter from a first user device. This parameter may define a simulation structure including a predefined number of simulation participants, an open selection pool of a plurality of geography-linked selections, one or more scoring metrics based on at least one real-time data input, and a simulation duration. A user may enter a “Simulation Name” into a text field that may be stored in a structured database, and this “Simulation Name” may be assigned a unique simulation identifier to facilitate subsequent queries and updates. A “Description” box may allow the user to include additional contextual data or textual explanations, which may later be referenced when participant selection data is processed.

In some aspects, the simulation platform interface 602 may provide a “Date Range” dropdown menu that may dynamically generate a corresponding start date and end date. For example, selecting “1 Month” may set a start date of Feb. 3, 2025 and an end date of Mar. 5, 2025, or other durations may be configured as optional features. This date range may be considered one instance of the at least one simulation initialization parameter that the processing circuitry may store in the structured database and associate with the unique simulation identifier. In other variations, the user may independently specify a “Start Date” and an “End Date” if the date range is set to “Custom.”

In various aspects, the instructions residing on at least one non-transitory machine-readable medium may cause the processing circuitry to receive participant selection data after a user creates a new simulation. The interface may prompt the user to define the permissible picks, potentially representing at least one geography-linked selection. A user may elect to add additional data constraints, such as limiting the number of valid picks or specifying a list of eligible stocks. Upon entry, such participant selection data may be validated against at least one predefined simulation rule, which may further prevent improper or duplicate picks in the structured database.

In several aspects, the processing circuitry may obtain at least one real-time data input from an external data source if the newly created simulation is set to compute performance metrics. This real-time data input may include dynamically updating performance indicator values for geography-linked selections, allowing ongoing calculation of participant aggregated distribution weighting outcomes. The external data source may be an online market feed, an educational data repository, or another known data provider. This data flow may further align with an optional aspect wherein historical performance data is retrieved from the same or a second external data source to generate predictive performance insights for the one or more participant aggregated distribution weightings.

In many aspects, the “Bots” selection area may permit a user to designate artificial participant entries such as “Bench” or “Rando,” each of which may submit participant selection data automatically. By checking a box adjacent to “Bench” or “Rando,” the user may initiate instructions for creating randomly selected performance indicator values or other simulation-defined scoring coefficients used to weight participant entries. This creates an expanded environment in which the performance ranking may be dynamically updated not only for human users but for these artificial participants, broadening the potential dataset for real-time computations and comparative results.

In other aspects, the interface may include an option to set “Visibility,” which may govern whether the simulation is considered public or private. Setting Visibility to “Public” may mean that a publicly accessible simulation tracking interface may be automatically generated, including a simulation leaderboard that dynamically updates the performance ranking of the participant aggregated distribution weightings. Alternatively, setting the Visibility to “Private” may restrict simulation access to invitees or authenticated users. In one example, the system may configure a unique URL to allow limited-time access when the Visibility is set to “Public,” thereby reflecting a scenario in which the generated leaderboard is externally shareable and time-limited.

In certain aspects, a large “Create” button may be displayed beneath the form fields, which may send the at least one simulation initialization parameter to the relevant processing circuitry or remote server for storage. This operation may store the parameter in the structured database, ensuring that each simulation is assigned or updated with a unique simulation identifier. The instructions stored on the non-transitory machine-readable medium may be configured to apply at least one predefined computation rule to incoming real-time data inputs once all participant selection data has been associated with that unique identifier.

In some aspects, upon the user pressing the “Create” button, the system may generate a relational mapping of the one or more participant aggregated distribution weightings within the structured database. This mapping may include cross-references linking the user-provided geography-linked selections to the assigned unique simulation identifier. The system may then associate a default or user-defined scoring metric that applies throughout the simulation duration. For example, the metric may weigh certain short-term volatility measures or incorporate weighting coefficients that account for a simulation-defined level of selection difficulty.

In various aspects, the user may see a small textual line indicating “You have 1 active/open simulations (limit 5).” This message may inform the user that the system may hold a certain maximum number of concurrent simulations for each user. The system may optionally generate notifications if the user attempts to create more than five active simulations, reflecting an internal predefined eligibility criterion. The system may update simulation statuses automatically when the start date arrives, or it may close a simulation if not enough participants join, fulfilling earlier-defined rules for participant thresholds.

In several aspects, the system's memory may store instructions to handle real-time updates to the performance ranking once the start date has been reached. The performance ranking may be assigned to each participant aggregated distribution weighting based on the at least one real-time data input that arrives from an external data source. If one or more participants are bots, the system may periodically recalculate their positions, especially if the artificial participant entry was configured to adopt randomly selected picks. In another optional scenario, a chat module may be integrated into the publicly accessible simulation tracking interface, enabling users to exchange secure messages if the system supports such interactive features.

In many aspects, the “Bench” and “Rando” bots may incorporate different selection strategies. “Bench” may represent a aggregated distribution weighting that follows an established market index, while “Rando” may rely on random picks from among the open selection pool of geography-linked selections. These optional features may highlight a possible weighting approach, aligning with instructions that apply the at least one predefined computation rule to varied participant entries. If a user chooses to apply a performance-based highlight for a leading participant, a visual highlighting technique may be employed on the leaderboard to dynamically adjust fonts, backgrounds, or colors once a ranking threshold is surpassed.

In other aspects, if a user modifies any predefined simulation rule-such as changing the scoring method or altering a cutoff date-the system may detect this adjustment and generate a system notification transmitted to relevant user devices. The field “Description” in the user interface may document these changes, enabling participants to be informed of shifts in the simulation structure. If the system is configured to handle partial refunds or reassign participants to a new simulation, the user management module may store these transitions in the structured database, ensuring accurate relational mappings for all participant aggregated distribution weightings.

In certain aspects, the newly created simulation platform interface 602 may thereby implement the foundation for receiving simulation initialization parameters, storing them in a structured format, receiving participant selection data referencing geography-linked picks, retrieving real-time data from external sources, and applying a predefined computation rule to determine a performance ranking for each participant. The user's selection of “Public” or “Private” visibility may likewise dictate whether the system constructs a publicly accessible simulation tracking interface. If public, the simulation leaderboard may be accessible through a unique URL that may expire after a predefined duration or upon simulation completion, depending on system settings.

In some aspects, each of these sequences may be integrated to ensure a comprehensive life cycle for simulations. The first user device may transmit the initialization parameters and trigger the creation of a unique simulation identifier. Then, the user and any artificial participants may submit selection data validated against an eligibility criterion. The system may generate an active state for that simulation, retrieve dynamic performance data from a remote feed, and systematically assign ranking positions. Should a user close the interface and return later, the memory storing instructions may retrieve the updated ranking, reinforcing continuous access to the leaderboard.

In various aspects, the entire arrangement may demonstrate how a combination of software modules and user-facing forms may implement each feature set recited by instructions on at least one non-transitory machine-readable medium. By including options for advanced analytics, participants' scoring metrics are adjusted whenever the at least one real-time data input changes. Historical performance data might additionally be used if the user opts for deeper predictive insight. Moreover, if the user chooses a performance-based or milestone-based simulation type, the system may adapt how it displays partial results, highlight thresholds, or compute overall winner designations.

In several aspects, the user interface layout shown in FIG. 6B may be rendered on a range of display environments, such as laptops, tablets, or mobile phone screens, thereby offering a responsive or modular experience. The text fields, dropdown, and checkboxes may be built with standard web frameworks, which may expedite deployment across various operating systems. The system may maintain logs of any changes to the “Simulation Name,” “Description,” or “Date Range” for compliance or historical reference in case an administrative audit is triggered. This mechanism may further bind a given user's device ID to the unique simulation identifier for future reference.

In many aspects, the disclosed arrangement of elements within FIG. 6B may serve as a foundation for expansions and customizations. For example, a user may select multiple “Bots,” each with distinct scoring strategies, or specify custom weighting factors for different geography-linked selections. The start and end dates may be dynamically adjustable according to market holidays or user preferences, thereby showcasing optional embodiments where weekend or holiday constraints apply to the real-time data input. This flexible approach may underline how the instructions stored in memory may easily incorporate additional layers of logic without straying from the disclosed features.

In other aspects, upon completing the “Create Simulation” workflow, the system may immediately generate an initial performance baseline in the structured database, anticipating future updates once real-time indicators become available. If the user sets the date range to “1 Month,” the structured database may lock in the final configuration upon pressing the “Create” button, thereby associating the user's picks with the new simulation. The system may then transmit confirmation details to the first user device and optionally to other user devices via a push notification or electronic message, providing a link that leads participants directly to the newly established simulation's interface.

In certain aspects, the simulation platform interface 602 described in FIG. 6B may therefore provide a comprehensive mechanism for receiving the at least one simulation initialization parameter and creating new simulations in alignment with the disclosed functionality. The interplay of the “Create Simulation” form, the structured database maintaining unique identifiers, and the real-time performance data acquisition collectively support dynamic scoring, ranking, and user interaction throughout the simulation duration. This cooperatively ensures that any selection of a geography-linked pick, potential weighting coefficients, or artificial participant scenarios is integrated under a common framework, enabling the generation of a publicly accessible simulation tracking interface and persistent, flexible user engagement. Referring to FIG. 6C, interface 604 may provide a display through which a first user device transmits participant selection data corresponding to at least one predefined simulation rule. In certain aspects, interface 604 may show a left navigation panel featuring a “My Simulations” button, “Create Simulation” button, and “Public Simulations” button, each of which may facilitate navigation to different system functionalities that receive or manage at least one simulation initialization parameter. In various aspects, interface 604 may be rendered using web-based technologies, such as HTML or JavaScript frameworks, although other software environments may be used to implement the display logic. Interface 604 may be hosted on a server or locally on a user device, and it may communicate with a structured database to store entered parameters and retrieve relevant real-time data updates from at least one external data source.

In some aspects, a title label 620 may read “Make your picks!” to prompt a user to specify participant selection data for a simulation structure that may include a predefined number of simulation participants, an open selection pool of a plurality of geography-linked selections, one or more scoring metrics based on real-time data, and a simulation duration. The phrase “Simulation: Simulation” may be displayed, indicating the name or unique descriptor chosen by a user or assigned by the system in response to receiving at least one simulation initialization parameter. In certain aspects, a date range label 622 may indicate the selected simulation duration (e.g., Jan. 30, 2025-Mar. 5, 2025), reflecting user input or default system parameters that define the timeframe for gathering performance indicator values. This date range label 622 may correspond to the at least one simulation initialization parameter stored in the structured database to manage the simulation start and end times.

In many aspects, interface 604 may display five pick input rows, each row including a text input field 624 for entering a geography-linked selection and a position selector 626 to specify “Long” or “Short.” A user may thus choose “CIPO,” “CNIPA,” “JPO,” “KIPO,” and “USPTO” in the respective text input fields 624 and designate each as “Long,” although each position may optionally be “Short,” depending on one or more participant aggregated distribution weightings or user preferences. In other aspects, the number or arrangement of picks may be modified depending on the corresponding predefined simulation rule. For example, if a simulation initialization parameter indicates that fewer or more picks are permitted, interface 604 may dynamically display a different number of input rows. In certain aspects, the user device receiving these picks may generate participant selection data referencing at least one geography-linked selection, and this data may be validated against eligibility criteria before being associated with a unique simulation identifier within the structured database. In various aspects, the user's selection data may be validated to confirm adherence to any system-imposed restrictions, such as restricting certain geographically linked stocks or indexes to particular user tiers.

In several aspects, interface 604 may include a “Submit” button 628 that, when activated, may cause the processing circuitry to store the participant selection data in the structured database. This “Submit” button 628 may trigger operations defined by instructions stored on at least one non-transitory machine-readable medium, causing the processing circuitry to receive the selection data and map it to the unique simulation identifier. In some aspects, once the user presses the “Submit” button 628, the system may proceed to associate the participant data with simulation parameters, which may include at least one simulation initialization parameter such as an open selection pool or a predefined number of participants. In other aspects, pressing the “Submit” button 628 may initiate a check to determine if the user's chosen picks meet all predefined simulation rules, prompting an error if an invalid selection is found or if the user has exceeded a maximum pick limit.

In certain aspects, the user interface text “Submissions must be in by midnight on the last day before the simulation starts” may reflect an optional eligibility cutoff, aligning with the concept that participant selection data is locked prior to performance calculations. In many aspects, this cutoff may be enforced by the system, meaning that any picks received beyond that timestamp may be rejected or flagged within the structured database for review, depending on the system design. This approach may help maintain consistent data for real-time updates obtained from at least one external data source.

In other aspects, the text inputs for picks, such as pick 1 text input field 624 or pick 2 text input field 624, may interpret entries as geography-linked selections referring to different worldwide markets or indices. A user device might specify, for example, “CIPO” to reference a certain stock or index in a particular country. This approach may align with the claim requirement that at least one geography-linked selection may be chosen by one or more participant aggregated distribution weightings. Once the structured database confirms that the picks align with permissible inputs, the system may retrieve real-time market data from an external data source to produce dynamically updating performance indicator values.

In some aspects, different scoring metrics may be assigned based on the user's “Long” or “Short” position for each pick, where a short position might indicate that a aggregated distribution weighting stands to gain if the market value declines. In various aspects, the system may then store these positions in a table keyed to the unique simulation identifier, ensuring that each user's chosen picks are distinguished and accessible for subsequent computations. In certain aspects, these computations may apply at least one predefined computation rule to the real-time data, generating a performance ranking for the participant aggregated distribution weightings. The user interface depicted in FIG. 6C may thus represent the step prior to real-time computation, wherein users or participants define and confirm their picks.

Optional embodiments of the system may include invite-based simulation access, alt-account detection measures, and integration with third-party payment platforms. For example, organizers may require an invite token for simulation entry, and backend logic may flag accounts exhibiting duplicate behavior patterns. Additionally, token-based reward mechanisms or external payout modules may be integrated for verified simulations involving incentive structures.

In several aspects, the user interface environment in FIG. 6C may be built using standard web protocols (e.g., HTML over HTTP), but other architectures are possible, such as mobile applications or virtual reality-based front ends. The user device that interacts with interface 604 may be a smartphone, a personal computer, or a specialized terminal, depending on the environment in which the software platform operates. In many aspects, security measures may be introduced to protect the transmission of participant picks, potentially including encryption protocols that align with system-level confidentiality. This may ensure that only authorized participants may input or modify picks, satisfying optional constraints found in the broader disclosure.

In certain aspects, the instructions stored on the at least one non-transitory machine-readable medium may cause the processing circuitry to further include a dynamically updating performance ranking once the simulation begins. The displayed picks for “CIPO,” “CNIPA,” “JPO,” “KIPO,” and “USPTO” may be assigned initial baseline values retrieved from an external data source. In some aspects, a weighting factor may be assigned to each pick if the system's predefined computation rule accounts for volatility or selection difficulty. In various aspects, such weighting may be optional and only relevant to specific simulations configured by the user when setting the at least one simulation initialization parameter.

In other aspects, the system may optionally generate an artificial participant entry as outlined in the broader disclosure, injecting randomly selected performance indicator values into the simulation. This approach may be activated by selecting a designated “bot” toggle in a separate user interface, but it may still be relevant to picks in FIG. 6C if the user designates an automated participant. In certain aspects, such a bot participant may adopt one or more picks and store them in the structured database under a separate participant ID. The system may then compute a performance ranking that includes both organic and artificial participants, merging them in the same public leaderboard as described elsewhere.

In several aspects, each pick text input field 624 may accept free-form text or a drop-down selection bound to a list of valid geography-linked stocks or indexes. The figure specifically shows the example text strings “CIPO,” “CNIPA,” “JPO,” “KIPO,” and “USPTO,” but many other strings exist. In some aspects, a user may specify a custom symbol if the system's open selection pool extends to other markets or geographies, provided that the external data source may supply real-time performance indicator values. In many aspects, the frequency of retrieving these indicator values, such as every minute or every hour, may be defined in the system's configuration files or may be determined by a user preference during simulation initialization.

In certain aspects, once the “Submit” button 628 is activated, the system may generate a relational mapping within the structured database, associating each pick with the unique simulation identifier. This mapping may store additional metadata, including the time of submission and the participant's user ID. In various aspects, if the user changes picks before the stated midnight cutoff, the system may update the structured database with the revised data, discarding older picks to prevent double counting or inconsistent ranking. In some aspects, an automated process may send each user a system notification if a pick is flagged as invalid or if a previously valid pick becomes ineligible, for example, due to updated real-time data from an external data source.

In other aspects, the publicly accessible simulation tracking interface, described generally elsewhere, may reflect these picks in a leaderboard view after the simulation start date. The system may apply at least one predefined computation rule to measure how each pick's actual market performance differs from a chosen baseline, thereby generating a performance ranking that determines which aggregated distribution weightings are most successful. In certain aspects, if the user selected a short position in the text input field 624, negative changes in the market value might generate positive returns, aligning with typical short-selling principles. The structured database may store these computations in an organized fashion, ensuring the dynamic ranking remains accurate.

In several aspects, the user interface shown in FIG. 6C may incorporate advanced visuals or analytics, such as color-coding to signify upward or downward movement of picks, although FIG. 6C shows a simpler textual layout. In many aspects, the system may support additional complexity, including separate modules or processes that retrieve historical performance data and generate predictive insights. These predictive insights may allow participants to see potential future outcomes for each geography-linked selection, corresponding to an optional feature in which the external data source is queried for historical data as well as real-time metrics.

In certain aspects, the entire environment that implements interface 604 may transmit a unique URL to each participant, enabling limited-time access to the publicly accessible leaderboard. This approach may be used if the user device is not permanently logged in or if a simulation organizer desires to share read-only views with external observers. In some aspects, the URL may expire after the simulation ends, consistent with optional features in the broader system structure. The method of distributing this URL may include emailing, texting, or posting within a secure communication channel, aligning with potential features for interactive chat modules.

In other aspects, the figure's depiction of “Log Out” in the top right corner suggests that authenticated users may exit their sessions once picks are submitted. This approach may be vital for multi-participant simulations where each user device is associated with a distinct user account in the structured database. In several aspects, the system may require a new login upon re-entering interface 604, ensuring that only individuals with valid credentials may alter or view participant selection data.

In many aspects, the arrangement of the interface elements, such as the “My Simulations,” “Create Simulation,” and “Public Simulations” buttons, may vary for different embodiments. The system may present these options through a dropdown menu, a series of icons, or voice-activated commands, as long as the essential function of receiving at least one simulation initialization parameter and storing it in the database is maintained. The “Pick” labeling might be customizable, allowing a participant to rename “Pick 1” to “Pick A” or something more descriptive, without departing from the underlying operations of receiving participant selection data.

In certain aspects, FIG. 6C's structure of textual labels and input fields may be physically implemented using a touchscreen display, a mouse-and-keyboard interface, or other forms of hardware input. The instructions that define how these interactions update the structured database may reside on the at least one non-transitory machine-readable medium, ensuring consistent handling of each pick's data throughout the simulation duration. In various aspects, data stored in the structured database may be forwarded to back-end modules that apply the at least one predefined computation rule for computing performance rankings.

In some aspects, after a user completes filling out picks in text input fields 624 and position selector fields 626, the user device may display confirmation messages or invitations to share the posted simulation link. This ensures that newly enrolled participants may find the same interface 604 and submit their own picks, potentially referencing different geography-linked selections. In other aspects, an administrative overlay might let an organizer define whether the user may edit picks after submission but before the midnight cutoff, or whether picks become permanently locked upon initial submission. If picks remain editable, the structured database may track each version, enabling the system to confirm that final picks align with the relevant predefined simulation rules.

In several aspects, once the simulation officially starts at the specified date range, interface 604 may no longer allow changes to picks. The system, upon receiving real-time feeds from the external data source, might display dynamic returns or percentage changes next to each pick, facilitating transparent monitoring. These returns may feed into the performance ranking, eventually placing each participant (and any artificial participant entries) in a particular position based on their accumulated scores or gains. In many aspects, that ranking may be displayed in a separate publicly accessible interface, or within the same interface 604 upon a user selecting an option that says “View Leaderboard.”

In certain aspects, the robust configuration of interface 604 described here may illustrate how participants control the simulation structure, define picks, and finalize data. This arrangement may be used in conjunction with other system elements, such as a unique URL or visual highlighting techniques that reflect rank thresholds. In various aspects, the underlying processing circuitry may handle numerous concurrent simulations, each with separate participants, picks, and real-time data streams. The user interface design of FIG. 6C may therefore represent but one iteration of a broader, flexible platform for receiving, validating, and storing picks, applying real-time data, and updating performance rankings accordingly.

In other aspects, the text input fields 624 may accept alphanumeric strings representing specialized indices or curated stock groupings. The “Long” or “Short” dropdown menus 626 may optionally include additional strategies (e.g., “synthetic positions” or “option-based positions”), if the system is configured to handle more advanced trading simulations. However, if only time-based or performance-based simulations are used, these specialized fields might remain unused, thereby reiterating how the entire system may adapt to different subsets of the claimed functionalities.

In several aspects, FIG. 6C may thus demonstrate the basic approach of receiving participant selection data according to a defined set of simulation rules. Once these picks are stored under a unique simulation identifier, subsequent operations may obtain a real-time data feed, compute performance rankings, and generate a publicly accessible leaderboard. In many aspects, each pick is specifically tied to geography-linked selections, allowing for a broad range of markets, indices, or securities to be integrated into a single simulation scenario. This arrangement may foster a rich and interactive user experience that aligns with the requirements for dynamic updating and open simulation structures, as described in the broader disclosure. In certain aspects, simulation platform interface 606 may display a user-facing layout in which at least one simulation initialization parameter is presented for participant review and potential modification. This interface may enable a first user device to receive or update data relating to a predefined number of simulation participants, an open selection pool of a plurality of geography-linked selections, one or more scoring metrics based on at least one real-time data input, and a simulation duration. In various aspects, the upper portion of simulation platform interface 606 may contain an invitation link that may be shared with additional participants, reflecting a unique URL that may allow limited-time access in some implementations. This URL may correspond to a publicly accessible simulation tracking interface that may dynamically update throughout the simulation duration, which aligns with the concept of generating a leaderboard that may display performance rankings in real time.

In some aspects, a left-side panel of simulation platform interface 606 may include a “My Simulations” button, a “Create Simulation” button, and a “Public Simulations” button, each of which may serve as a navigational element for different parts of the system. The “My Simulations” button may allow a user to review previously created simulations or simulations in which they are already participating, while the “Create Simulation” button may facilitate receiving at least one new simulation initialization parameter. That parameter may be stored in a structured database after being assigned a unique simulation identifier. In certain aspects, the “Public Simulations” button may provide a user with an overview of open simulations that do not require explicit invitation, thereby enabling wider collaboration or expanded participation.

In many aspects, the display area labeled as “Simulation” on simulation platform interface 606 may show that there are 20 hours remaining before the simulation start time of Jan. 30, 2025, lasting until Mar. 5, 2025. This time-based structure may demonstrate how the at least one simulation initialization parameter may include a start date and end date defining the simulation duration. In other aspects, the interface may convey that all entries must be submitted by midnight Eastern Standard Time on the date before the simulation begins, reflecting at least one predefined simulation rule regarding participant eligibility or submission timings. In this way, the system may validate participant selection data against a set of constraints prior to associating the participant selection data with the unique simulation identifier.

In several aspects, an on-screen message may indicate a prerequisite of “10 participants” to start, thereby showing that the simulation structure may define a predefined number of simulation participants, such that if fewer participants join, the simulation may be closed and a new one may need to be created. This requirement may be included in the at least one simulation initialization parameter. In certain aspects, the text “Change Picks” button 640 may be displayed, potentially enabling a user to modify or update participant selection data prior to the submission deadline. This participant selection data may include a selection of at least one geography-linked selection, which may be defined by a user's chosen stocks, indexes, or similar security-based entries.

In other aspects, the area beneath the table labeled “User” and “Picks” may illustrate how different participant aggregated distribution weightings are identified and how their choices are visually presented. Here, “Bench” and “Rando” may both represent examples of artificial participant entries in line with a feature that may generate at least one artificial participant entry using randomly selected performance indicator values. These artificial participant entries may receive real-time data from at least one external data source to simulate participant performance throughout the simulation. In certain aspects, “user1” is shown as selecting geography-linked picks labeled “CN,” “JPN,” “CA,” “KOR,” and “MX,” each of which may remain subject to validation against at least one predefined eligibility criterion before the system assigns these picks to the unique simulation identifier stored in a structured database.

In many aspects, once the system receives participant selection data from user1 and any other participants, it may associate that data with the unique simulation identifier in a relational mapping. The system may then obtain at least one real-time data input from an external data source, potentially involving continuous performance indicator values that reflect changing market or index conditions. In certain aspects, the system may apply at least one predefined computation rule to these dynamically updating performance indicator values, generating a performance ranking for each participant aggregated distribution weighting. In many scenarios, weighting participant entries based on a difficulty coefficient, or factoring in milestone-based scorings, may be optionally included within these computation rules. Accordingly, once the start time arrives, the underlying processing circuitry may handle all necessary calculations to assign ranking positions in real time.

In various aspects, the requirement that all entries must be submitted by a specified time ensures that the base set of participant aggregated distribution weightings is locked in before the simulation commences. This approach may maintain fairness, as no participant may alter picks when the simulation is already in progress. In some aspects, if fewer than 10 participants have confirmed their selections by the submission deadline, the system may automatically close the simulation and generate a notification to relevant user devices regarding the change in status. This form of system notification may constitute an additional optional feature, where the system may send messages whenever at least one predefined simulation rule is modified or when certain thresholds are met, such as failing to meet the participant requirement.

In several aspects, the displayed link in the “Simulation” section of simulation platform interface 606 may represent a unique URL that further aligns with an option to allow limited-time access. This URL may be configured to expire after the simulation starts or upon reaching a certain date, consistent with overall security measures. In other aspects, participants who click the URL may view or edit their selections, or in some configurations, they may only have read-only visibility of the leaderboard. Such a leaderboard may be updated dynamically based on the real-time performance indicator values from the external data source. In certain aspects, the leaderboard's visual highlighting techniques may differentiate standings according to one or more ranking thresholds, such as color-coding the top three positions or shading entries that fall below a minimum performance percentile.

In many aspects, the “Change Picks” button 640 may signal to the processing circuitry that additional input is being submitted, prompting the system to again receive participant selection data. This subsequent data may be re-validated and re-associated with the same simulation identifier, though certain rules may limit how many times a participant may change picks or whether changes are disallowed after a specific cutoff. The system may then store any updated parameter into the structured database, ensuring that each participant's aggregated distribution weighting remains accurately recorded.

In certain aspects, the presence of “Bench” and “Rando” as artificial participants may demonstrate a technique for testing or enriching simulation interactions. The system may retrieve historical performance data from the external data source to create plausible random picks or to generate predictive performance insights for these artificial entries. In some aspects, these artificial participants may be set to replicate real market conditions or may simply operate on an algorithmic strategy that picks random entries from the open selection pool of geography-linked selections. This mechanism may add variety to the simulation environment, providing more data points for scoring metrics.

In other aspects, the user interface may display a “Log Out” option in the top corner, which may indicate that authenticated users may securely manage their simulations through user credentials. Alternatively, the system may enable an interactive chat module if authorized, thereby allowing participants to converse about the running simulation. Such a chat module may be embedded within the same publicly accessible tracking interface, conforming to optional features for user engagement.

In several aspects, the timeframe of “Starts in 20 hours” may highlight how a time-based simulation type is configured, aligning with at least one predefined simulation type selected from a group including time-based, performance-based, or milestone-based simulations. In many scenarios, once that 20-hour countdown elapses, the system may automatically begin collecting real-time data from the external data source and applying the predefined computation rules to determine each participant's performance ranking. The updated rankings may be displayed to all authorized participants via the publicly accessible simulation tracking interface.

In certain aspects, the phrase “All entries must be submitted by 12:00 AM EST the night before the simulation starts” suggests that any participant selection data received after that deadline might be disqualified or set aside. This approach may ensure an orderly commencement of the simulation structure, further meeting the recited approach of receiving participant selection data according to a predefined simulation rule. At the same time, the structured database may log each submission time, associating entries with the unique simulation identifier in a systematic manner.

In some aspects, if a user attempts to join after the deadline, the interface may deny submission of new participant selection data until the next available simulation. In other implementations, the system may allow late entries but weight them differently through the predefined computation rule. Such weighting may, for example, reduce the maximum possible standing a tardy participant may achieve, reflecting an optional variant on the scoring approach. In many scenarios, though, the primary flow is that new participants are prevented from making picks after the stated cutoff, reinforcing overall fairness.

In various aspects, once the simulation officially starts, the performance ranking may be computed in near real time using the one or more scoring metrics defined in the at least one simulation initialization parameter. This performance ranking may be updated on a rolling basis whenever new performance indicator values arrive from an external data source. The dynamic nature of this process may encourage repeated visits to simulation platform interface 606 as participants track their positions. In certain aspects, if any modifications occur to at least one predefined simulation rule mid-simulation, the system may generate a system notification that is dispatched to all participant devices.

In several aspects, the underlying hardware used to implement simulation platform interface 606 may include a screen-based user input device running on a computing environment, potentially a laptop, smartphone, or tablet. The instructions executed by the processing circuitry may be stored on at least one non-transitory machine-readable medium. This medium may be configured to handle both the code that processes user submissions and the data structures holding each simulation's unique identifier. The memory environment may store a record of the real-time data feeds used for computing each participant's aggregated distribution weighting performance.

In some aspects, this interface may be sufficiently modular that different application programming interfaces (APIs) or third-party data sources may be swapped in as external data providers. The system may be configured to handle additional functionalities, such as automatically retrieving historical performance data for each geography-linked selection, thereby enabling predictive insights regarding how each aggregated distribution weighting may perform. In other aspects, the system may include logic for weighting participant entries if certain chosen stocks are deemed more difficult to predict, further showcasing how the at least one predefined computation rule may expand to account for complexity factors.

In many aspects, the synergy of an updated countdown timer, a publicly shareable link, artificial participants labeled “Bench” and “Rando,” and real user picks reveals how the system may incorporate both standard participant selection data and randomly generated entries. By combining these elements, the interface depicted in simulation platform interface 606 may fulfill the operational requirements for receiving, storing, associating, analyzing, and displaying participant data, thereby providing a transparent and dynamically updated leaderboard. This comprehensive approach may facilitate broader adoption, whether the simulation type is purely time-based, performance-based, milestone-based, or augmented by additional scoring coefficients.

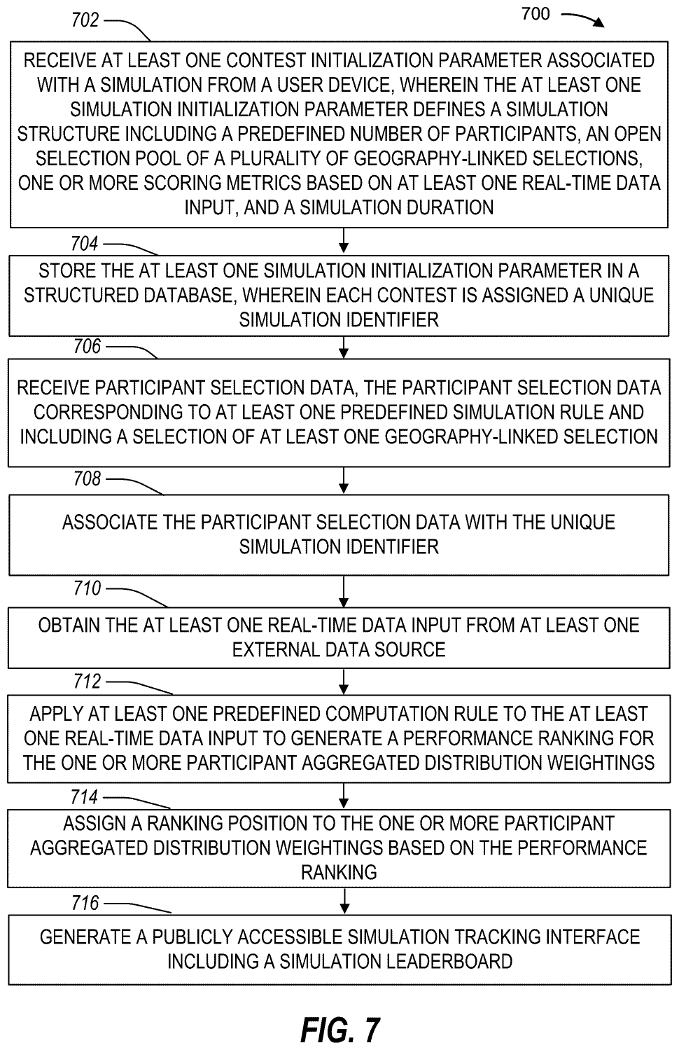

FIG. 7 illustrates a flowchart depicting a technique 700 for managing a simulation platform.

The technique 700 includes an operation 702 to receive at least one simulation initialization parameter associated with a simulation, entered by a first user device. The simulation initialization parameter may define a simulation structure that includes a predefined number of participants, an open selection pool of a plurality of geography-linked selections, one or more scoring metrics based on at least one real-time data input, and a simulation duration. In some aspects, the predefined number of participants may vary widely, such as two participants or hundreds of participants, depending on deployment. In many aspects, these simulation initialization parameters may be submitted through a user-facing interface that allows the user to specify whether the simulation type is time-based, performance-based, or milestone-based. This step 702 may be performed by processing circuitry that handles user inputs, potentially verifying any textual descriptions or dropdown menu selections. In other aspects, a participant might define a custom duration using calendar inputs, or might select from preset durations (e.g., one month, three months). In several aspects, the open selection pool may be configured to handle stock symbol data, index funds, or other geographically linked assets. In certain aspects, one or more scoring metrics may be tied to real-time price movements, daily closing values, or advanced analytical indicators, which may be retrieved at later steps.

The technique 700 includes an operation 704 to store the at least one simulation initialization parameter in a structured database, wherein each simulation is assigned a unique simulation identifier. In certain aspects, the structured database may reside on a central server cluster running a NoSQL or relational architecture, potentially using a distributed environment for redundancy. In other aspects, the unique simulation identifier may be composed of alphanumeric code segments or hashed references, allowing efficient retrieval of simulation-specific records. In several aspects, storing the parameters may include associating user authentication details, such as security tokens, to maintain appropriate permissions for subsequent data input or retrieval. In many aspects, the system may store additional metadata, like whether the simulation is private or publicly accessible, or whether the simulation is limited to a particular user group. In some aspects, storing these parameters may involve temporarily caching them in memory for faster access, while the structured database persists them for consistent backups.

The technique 700 includes an operation 706 to receive participant selection data, the participant selection data corresponding to at least one predefined simulation rule. In many aspects, this participant selection data may include a user-chosen selection of at least one geography-linked selection, such as stocks, currency pairs, futures, or other market-tradable assets tied to specific locales. In some aspects, multiple participants may simultaneously submit their selections, prompting the system to check that each selection follows any simulation rule. In certain aspects, a predefined simulation rule may require participants to pick no more than five distinct symbols, or it may require that participants choose a balanced set of picks across diverse geographies and/or cultures. In other aspects, the system may validate data against at least one predefined eligibility criterion, such as time-based cutoff deadlines or special disclaimers for high-volatility assets. In many aspects, certain embodiments may permit the addition of at least one bot participant entry using randomly selected performance indicator values, thus simulating additional simulation as an optional feature.

The technique 700 includes an operation 708 to associate the participant selection data with the unique simulation identifier in the structured database. This relational mapping may allow the system to track which participant aggregated distribution weightings belong to which simulation. In several aspects, each participant aggregated distribution weighting may be represented by a digital record that includes the user's picks, current performance metrics, and optional notes on entry date. In other aspects, the structured database may maintain references that connect any given participant's selection to the relevant geography-linked assets. In certain aspects, the system may store all of these associations in specialized tables or collections that permit quick lookups of participant aggregated distribution weightings, thus supporting real-time operations. In many aspects, if the participant data fails certain validations (e.g., a user tries to pick more than the allowable count of geography-linked selections), the system may reject the submission before finalizing the association. This ensures that each aggregated distribution weighting fulfills the minimum or maximum constraints outlined in the simulation type parameters.

The technique 700 includes an operation 710 to obtain the at least one real-time data input from at least one external data source (not numerically labeled in this figure). This external data source may deliver dynamically updating performance indicator values, such as real-time price quotes, historical performance data, or predictive signals. In some aspects, the external data source may be an API provided by a financial data vendor that refreshes security prices multiple times per minute. In other aspects, the external data source may feed in news-based sentiment analytics, which may be used in specialized scoring metrics. In certain aspects, retrieving historical performance data from the external data source may allow the system to generate additional insights, such as predictive weighting. In many aspects, configurable data-polling intervals may be set to ensure up-to-date results without overloading network resources. In several aspects, the system may handle fallback protocols, so that if the external data source goes offline, the most recent data may remain in local memory until new updates resume.

The technique 700 includes an operation 712 to apply at least one predefined computation rule to the at least one real-time data input, generating a performance ranking for the one or more participant aggregated distribution weightings. In many aspects, this computation rule may factor in daily price movements, aggregated distribution weighting diversification, or custom weighting coefficients. In several aspects, the computation rule may be polynomial-based, exponential-based, or a simpler arithmetic approach. In some aspects, weighting participant entries based on a simulation-defined scoring coefficient may account for differences in selection difficulty or predicted volatility. Thus, aggregated distribution weightings that select a more volatile geography-linked selection might obtain a higher potential reward weight. In other aspects, the system may retrieve historical performance data for a participant's picks in order to model potential growth or risk, with the result feeding into the dynamic performance ranking. In certain aspects, the performance ranking may be updated automatically whenever the external data source refreshes values, ensuring near real-time recalculations of each aggregated distribution weighting's position.

The technique 700 includes an operation 714 to assign a ranking position to the one or more participant aggregated distribution weightings based on the performance ranking. In certain aspects, ranking positions may be displayed as numerical placements, such as first place, second place, and so on. In several aspects, ties may be broken by referencing secondary metrics-like a aggregated distribution weighting's prior day performance or a tiebreaker function that accounts for earliest submission time. In some aspects, ranking assignment may consider minimal thresholds that separate top performers from lower-tier performers, optionally employing a visual highlighting technique. In many aspects, the system may store the assigned ranking positions in the structured database, permitting retrieval by user-facing interfaces. In various aspects, assigning a ranking position may lead to generating system notifications or dynamic updates that appear in a chat module. This chat module may manage real-time user conversations about the standings or anticipated market shifts.

The technique 700 includes an operation 716 to generate a publicly accessible simulation tracking interface including a simulation leaderboard, where the simulation leaderboard dynamically updates the performance ranking of the one or more participant aggregated distribution weightings. In certain aspects, the interface may be accessible via a browser-based application, mobile app, or specialized user portal. In some aspects, a unique URL may be created for each simulation's public interface, allowing participants to view the leaderboard for the duration of the simulation or for a limited time. In several aspects, the interface may optionally feature an interactive chat module, permitting authenticated participants to exchange messages. In other aspects, the interface may format the leaderboard using at least one visual highlighting technique, potentially applying distinct color borders or font sizes to participants who exceed certain ranking thresholds. In many aspects, these thresholds may be dynamically adjusted, so if additional participants join or if real-time market data shifts drastically, the system may recalculate which positions deserve highlighting. In certain aspects, the publicly accessible simulation tracking interface may integrate additional statistics, such as day-over-day changes in each aggregated distribution weighting's returns, top gainers, or the best geography-linked selections across the entire simulation.

In some aspects, the technique 700 depicted in FIG. 7 may be executed in a different order, depending on design requirements. For example, the system may receive partial participant selection data before verifying all simulation initialization parameters, or it may request final confirmation from the user before step 708 associates the data with the unique simulation identifier. In other aspects, the data retrieval intervals may be adaptively scheduled, so that step 710 obtains the at least one real-time data input at gradually increasing or decreasing frequencies, depending on network conditions or user preferences. In several aspects, more advanced logic may be implemented at step 712, such as retrieving historical performance data from external analytics platforms to produce predictive performance insights. In many aspects, the system may generate artificial participant entries, which might occupy ranking positions if the simulation includes bots or random selections for demonstration.

In various aspects, the hardware or software enabling each step of the technique 700 may be hosted on cloud-based servers or on localized on-premise infrastructure. The instructions for performing the technique may be stored on at least one non-transitory machine-readable medium, enabling processing circuitry to handle incoming user data, real-time performance indicator values, and the generation of dynamic simulation leaderboards. In certain aspects, the structured database involved in steps 704 and 708 may store not only the simulation initialization parameter but incremental snapshots of each participant aggregated distribution weighting's performance. In other aspects, user devices may connect to the environment through a secure communication protocol, ensuring that validated participant selection data is protected from unauthorized interference.

In many aspects, additional features may be supported to expand upon this baseline flow. For example, the system may generate a system notification or email if a predefined simulation rule is amended during the ongoing simulation, allowing participants to reevaluate their picks. Likewise, a short-term milestone-based simulation might automatically end when a performance threshold is met, enabling the system to finalize the ranking positions earlier than the full duration. In some aspects, the generated publicly accessible interface may restrict access to certain geographical IP ranges if that aligns with the open selection pool or if local regulations require limited-time or region-based rules. In several aspects, the data retrieval for real-time performance indicator values may be replaced or augmented with AI-based price forecasts that feed directly into the computation rule for more advanced ranking outcomes.

In other aspects, technique 700 may be iterated repeatedly for multiple simulations operating in parallel, each with its own unique simulation identifier, set of participant selection data, and real-time data feeds. This flexibility may allow the system to manage thousands of simultaneous simulations, with each performance ranking being continually updated. In certain aspects, the leaderboard for each simulation may incorporate clickable data visualizations that reveal in-depth analytics of the participant aggregated distribution weightings, including individual pick performance or aggregated statistics. In many aspects, the memory storing instructions for technique 700 might incorporate advanced data-structure indexing, ensuring that real-time lookups remain efficient even at large scales. In some aspects, scoring metrics might factor in user interactions or community-based signals if a chat module becomes an additional data source, although such an extension remains optional and dependent on the chosen computation rule.

In several aspects, each step in FIG. 7 may be implemented in modular software routines, meaning developers may selectively enable or disable features such as the unique URL generation, visual highlighting, bot generation, or predictive insights. By structuring these steps as independent modules, the system may accommodate different use cases ranging from small private simulations to large-scale corporate events. In certain aspects, data from external data sources might require decryption or authentication, prompting additional layers of security or user permissions. In many aspects, high-level encryption protocols may protect the real-time data input received at step 710 so that user devices remain confident in the integrity of the ranking computations.

In some aspects, the storyline captured by technique 700 may be expanded to integrate multiple software frameworks, such as fast in-memory caching for short-lived data or extensive reporting tools for final simulation results. The final step 716 that generates a publicly accessible simulation tracking interface may connect with content delivery networks, ensuring rapid distribution of ranking updates worldwide. In several aspects, the interface may provide optional advanced filtering or sorting, enabling participants to compare aggregated distribution weighting performance across different sub-regions, or to highlight certain categories of geography-linked selections. This approach may broaden the educational and competitive appeal of the entire platform, merging real-time data with an intuitive user experience to keep participants engaged.

In various aspects, each step from 702 to 716 may be repeated in iterative cycles, especially for simulations that support mid-simulation updates or daily re-ranking. The system may periodically re-execute step 710 to gather new performance indicator values, reapply step 712 to compute updated standings, reassign step 714 ranking positions, and refresh step 716 with the new leaderboard data. Through the use of at least one predefined computation rule, this cyclical update may accommodate ongoing real-time changes until the simulation duration ends or the set milestone is reached. By offering flexible parameters, a robust structured database, and an automated flow, the disclosed architecture may serve a broad array of uses, from casual investment challenges to professional market simulations.

In certain aspects, at least one non-transitory machine-readable medium may store instructions that, when executed by processing circuitry, may receive at least one simulation initialization parameter from a first user device. This first user device may be any computational device, such as a laptop, desktop, mobile phone, or tablet computer, running an application or a browser-based interface that collects user inputs defining various facets of the simulation structure. In many aspects, the simulation structure may be transmitted securely over a network-such as the internet or a private intranet-to a server-side environment that includes both processing circuitry and memory. This server-side environment may function as the orchestration layer for the simulation, providing a robust hardware and software framework to facilitate real-time collaboration and concurrency control.

In some aspects, the at least one simulation initialization parameter may define a simulation structure including a predefined number of simulation participants, an open selection pool of a plurality of geography-linked selections, one or more scoring metrics based on at least one real-time data input, and a simulation duration. The user interface on the first user device may accept numeric entries for specifying the number of participants or might allow a user to select from preset simulation sizes. In certain aspects, the open selection pool may refer to publicly traded securities or national indexes linked to specific regions, such as Asia, Europe, or North America, although the architecture may support any other definable category of linked selections. In several aspects, one or more scoring metrics may measure real-time price fluctuations, volatility indexes, or daily performance aggregates retrieved from an external data source. This approach may improve the reliability of real-time data integration within a multi-user environment because it leverages a structured, automated process that is not practically performed within a human mind, given the complexity and the simultaneous data streams that must be processed, and often transferred many miles, at near-instantaneous machine and/or lightspeed.

In various aspects, the instructions on the non-transitory machine-readable medium may cause the processing circuitry to store the at least one simulation initialization parameter in a structured database, wherein each simulation is assigned a unique simulation identifier. The structured database may employ a relational schema or a NoSQL-based architecture, which may enhance scalability when handling large volumes of participant data. In many aspects, the unique simulation identifier may be auto-generated using hashing algorithms, random alphanumeric strings, or incrementing primary keys, ensuring that the system may manage concurrent user activities without collisions. This step may address a technical problem of concurrently storing and retrieving parameter sets for multiple simulations in real time, thus streamlining user workflows and reducing the risk of data corruption. The capacity to manage numerous simultaneous simulations efficiently may add a layer of technological improvement that goes beyond manual tracking or mental calculation.

In other aspects, the instructions may receive participant selection data from multiple user devices, each participant selection data corresponding to at least one predefined simulation rule. This participant selection data may specify which geography-linked selections a participant chooses to add to their aggregated distribution weighting. In certain aspects, the participant selection data may undergo validation against at least one predefined eligibility criterion before being associated with the unique simulation identifier. For example, an eligibility criterion may specify that each participant may pick up to five different geography-linked selections, or that each user must be authenticated through a secure channel to reduce the risk of unauthorized modifications. The validation logic may occur within the processing circuitry, which may query the structured database or an in-memory cache storing the simulation initialization parameter to confirm that the participant selection data is permissible for the currently active rules. Handling these checks automatically may solve the technical challenge of synchronizing user actions with dynamic rules, thereby reducing errors that might arise from manual, intangible oversight.

In several aspects, the instructions may associate the participant selection data with the unique simulation identifier to generate a relational mapping of the participant aggregated distribution weightings. This relational mapping may exist as a series of database records that link user IDs to their respective picks. By maintaining these associations in a structured database, the system may automatically track each participant's selections in real time, drastically reducing the complexity needed to manage large-scale simulations. Managing aggregated distribution weightings primarily in software, rather than through manual processes, may further address the technical difficulties of ensuring data integrity across multiple updates, since the system may enforce constraints and systematically replicate changes to backup nodes without operator intervention.

In certain aspects, at least one real-time data input may be obtained from at least one external data source, which may deliver dynamically updating performance indicator values corresponding to the chosen geography-linked selections. This external data source may be a market data feed, a financial analytics platform, or a specialized API aggregator that streams updates on price, volume, volatility, or other metrics. While incorporating anonymity with integrity for student continuity has been disclosed, often there may be established cultural trend analysis groups of prediction professionals whose participation in the school or education is limited to their estimate data integrations by way of grouped data/target averages, growth predictions, and/or Socratic commentary/debate on cultural evolution. In many aspects, this may bolster cooperation and social learning cross-culturally for beneficial mutual progress, including but not limited to diversity, equity, and/or inclusivity, both internationally and intra-nationally. Incorporating an external source that updates automatically allows the system to handle high-speed data refresh rates, a task ordinarily outside the scope of human mental calculation. This built-in automation solves a technical problem of timely data acquisition, ensuring that each participant's aggregated distribution weighting performance is computed on the most current figures.

In many aspects, the instructions may then apply at least one predefined computation rule to the at least one real-time data input to generate a performance ranking for one or more participant aggregated distribution weightings. Such predefined computation rules might include arithmetic or geometric weighting techniques, risk-adjusted scoring, or advanced machine learning-based evaluations. For example, some aspects might retrieve historical performance data from the external data source to generate predictive performance insights for the participant aggregated distribution weightings, thereby providing real-time forward-looking analytics. This approach may transform raw price updates into actionable metrics, delivering an improvement to computing technology that uses historical data sets in combination with real-time streams to provide dynamically updated results. Such computations are not realistically performed by mental processes alone, given the scale, speed, and volume of data being processed.

In several aspects, the instructions may assign a ranking position to the participant aggregated distribution weightings based on the performance ranking. This process may occur through the server's processing circuitry, which may compare performance scores, break ties according to specific logic, and store the newly assigned ranks in the structured database. Assigning these positions automatically helps resolve the technical challenge of distributing up-to-date leaderboard information across many simultaneous users. Because each participant's data is consistently maintained in digital form, the system may quickly recalculate the standings whenever new real-time data arrives, thus improving user engagement and the practicality of the platform as a real-time simulation environment.

In some aspects, the instructions may further generate a publicly accessible simulation tracking interface that includes a simulation leaderboard, wherein the simulation leaderboard dynamically updates the performance ranking in tandem with the at least one real-time data input. This leaderboard interface may appear in an HTML/JavaScript-based web application, a mobile application, or a specialized software client that visualizes each participant's standing. The system may optionally incorporate user authentication so that only authorized participants see the full range of data, or it may produce a partial read-only view for the public. Because the technology automatically distributes a real-time feed of ranking changes, it improves the speed with which participants may act upon new information, representing a technical solution that addresses data distribution over wide-area networks.

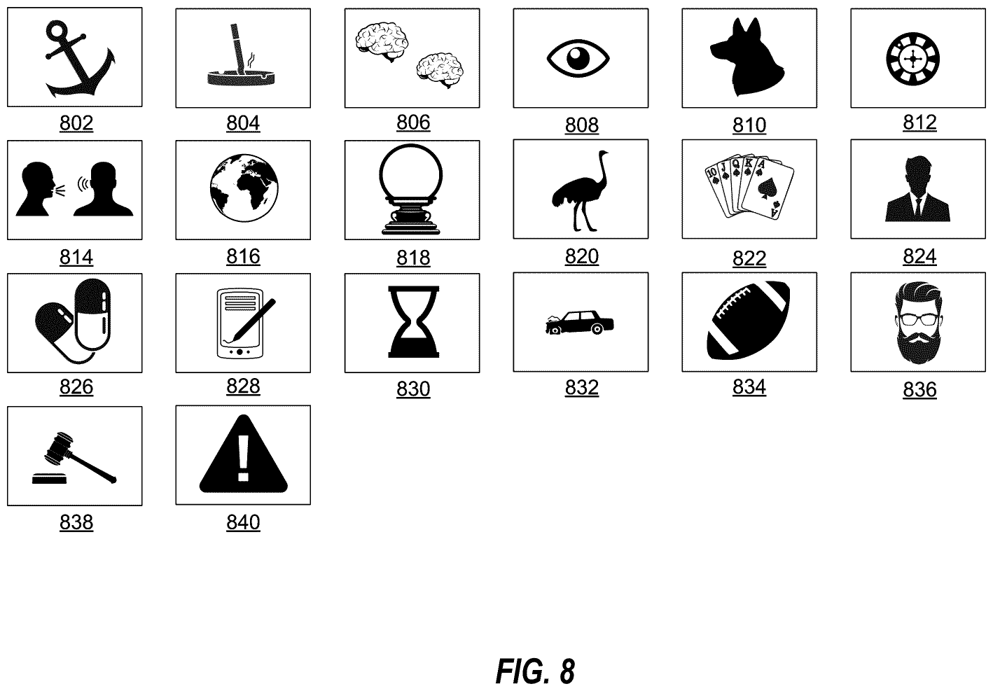

FIG. 8 illustrates a set of illustrative icons representing various cognitive biases that may be introduced into an industrial and international educational simulation platform, according to various examples.

In certain aspects, FIG. 8 may illustrate multiple icons, each labeled with a reference number (e.g., anchor 802, ash tray 804, brains 806, eye 808, dog silhouette 810, roulette wheel 812, conversation figure 814, globe 816, crystal ball 818, ostrich 820, playing cards 822, suited person 824, pills 826, handheld device 828, hourglass 830, wrecked car 832, football 834, bearded face 836, gavel 838, and warning sign 840). These icons may be stored in a structured database to support an open selection pool of potential user-facing reminders or cues regarding geography-linked selections and educational content focusing on psychological or cultural biases. In some aspects, these icons may be retrieved based on at least one simulation initialization parameter defining the scope of a simulation structure, including a predefined number of simulation participants and at least one real-time data input. In several aspects, the icons could be associated with each participant's aggregated distribution weightings to highlight or caution them about certain decision-making tendencies or to encourage them to explore industrial and international education modules in tandem with more conventional scoring metrics.

In various aspects, the anchor 802 may be associated with anchoring bias, which could be optionally displayed in a publicly accessible simulation tracking interface to alert participants that they may fixate excessively on an initial data point. This approach of layering cognition-focused icons onto the simulation leaderboard may be implemented by instructions stored on at least one non-transitory machine-readable medium that, when executed, cause a system to apply at least one predefined computation rule factoring each user's potential biases during the evaluation of performance indicator values. In certain aspects, if the system detects that a participant has consistently anchored on a specific price or stock dimension, it may generate a system notification regarding anchoring bias, referencing the anchor icon 802. Optionally, a configuration may define that the system presents a pop-up or inline message explaining how anchoring bias can impede dynamic updating of aggregated distribution weightings.

In some aspects, the ash tray 804 may communicate availability heuristic, providing an example of how external data sources or singular experiences might overshadow data-driven insights. This icon 804 may be displayed whenever the system determines that a participant's aggregated distribution weighting is disproportionately influenced by a recent piece of anecdotal evidence. The system may rely on memory storing code that, upon receiving participant selection data, compares multiple data sets-historical performance data or newly retrieved performance indicator values-and flags potential heuristics intruding upon rational weighting. In many aspects, once the system completes a weighting comparison, it may incorporate a simulation-defined scoring coefficient that accounts for difficulty in evaluating different picks. The user management unit, described in earlier figures, may store a user preference stating that availability-heuristic icons 804 appear only if the participant surpasses a threshold of recency-based adjustments, ensuring optional toggling for advanced participants.

In other aspects, the brains 806 may represent bandwagon effect, signifying that participants might adopt a strain of collective thinking if multiple user aggregated distribution weightings converge on identical geography-linked selections. The system, upon associating participant selection data with a unique simulation identifier, may track how rapidly or frequently participants adopt a newly popular selection. If the external data source indicates a cluster of participants pivoting to one specific region or industry index, the system may trigger a visual highlight of the brains 806 to show that a bandwagon effect has emerged. This highlight (or dynamic pop-up) may be considered an optional feature in a publicly accessible simulation tracking interface. In certain aspects, the method for displaying the icon can be integrated with a community forum or chat module, letting participants see that other users are adopting a particular stock due to groupthink, thus aligning with one or more scoring metrics that adapt in real time to this emergent pattern.

In several aspects, the eye 808 may convey blind-spot bias, prompting participants to recognize their personal biases in analyzing real-time performance indicator values. The system might detect that a participant consistently ignores warnings from the interactive chat module or real-time notifications. Under instructions stored in the structured database, a simulation processing unit may present the eye 808 in a leaderboard column or scoreboard reflection to remind participants that they may be overlooking their own predispositions. If the system identifies repeated contradictory picks that diverge from historical performance data or from logical constraints, it may rely on the eye 808 to highlight potential self-contradiction. This mechanism may be optional based on a simulation initialization parameter specifying that the simulation is performance-based with a focus on user introspection.

In other aspects, the dog silhouette 810 may reflect choice-supportive bias, encouraging participants to remain open to reevaluating picks. If the participant has initially chosen a set of picks that systematically underperform real-time data updates, the system may, via instructions executed by processing circuitry, display dog icon 810 in relation to those picks. This interface logic might further tie into a user's weighting coefficient, adjusting how major or minor changes are factored in subsequent real-time data inputs. In many aspects, the participant's final performance ranking may incorporate the user's consistent adherence to an underperforming pick, which can reflect over-commitment to a suboptimal choice. If a ranking threshold triggers, the system might incorporate a dynamic highlighting technique that modifies the color or size of the dog icon 810.

In certain aspects, the roulette wheel 812 may denote clustering illusion. If the system observes that participants see a presumed “pattern” (e.g., repeated short-term gains in random stock picks) and wrongly consider them indicative of future performance, the scoreboard or user interface might present the roulette wheel 812 as a caution. The memory storing programmatic instructions may set a bounding condition: whenever a participant invests in multiple random picks expecting a streak to continue, the interface uses a weighting dimension to highlight that these picks are not reliably correlated. In some aspects, the participant selection data validated against any predefined eligibility criteria might still allow these picks, but the user has the roulette wheel 812 displayed as a mild warning.

In various aspects, the conversation figure 814 may exemplify confirmation bias, which the system can highlight if the participant's picks are systematically skewed by seeking only supportive performance data. When the user or the “bot participant” picks are entered, the system may detect that limited data from the external data source was employed, ignoring contradictory historical performance. The user interface then draws on a referencing approach that shows the conversation figure 814 with a small note or tool tip about confirmation bias. This note might be integrated using a user management unit's configuration in which the user can choose to have a more or less detailed educational overlay. In certain aspects, these overlays might be toggled on a session-by-session basis, so as not to distract participants who prefer a more streamlined environment.

In some aspects, the globe 816 may demonstrate conservatism bias, explaining that participants could cling to older assumptions about a region's growth trend or exchange rate. If real-time data from the external data source indicates a shift in global market conditions, the system can compare that change to a participant's picks. If the participant fails to adjust, an alert or subtle highlight of the globe 816 may appear, cautioning that new data is not being factored proportionately. This can be implemented as part of the system's at least one predefined computation rule that calculates the performance ranking. The weighting approach might place an emphasis on how quickly or slowly a participant adapts to changed conditions, an optional feature encompassed by some dependent claims that focus on adaptive or milestone-based simulations.

In many aspects, the crystal ball 818 might represent information bias, warning participants that acquiring excessive data points may not necessarily yield better performance. The system may detect repeated fetch requests from the user device for external data source expansions, such as oversampling or microvariations. If a participant does not effectively integrate these extraneous data sets into improved picks, the system might highlight the crystal ball 818 to encourage them to reevaluate. The user management unit might store a threshold for “overactive polling,” and once that threshold is surpassed, the system can optionally display the crystal ball icon in the simulation leaderboard to remind the user “more data is not always more clarity.” The ephemeral presence of the crystal ball 818 might vanish if the participant migrates to a stable selection approach.

In other aspects, the ostrich 820 may illustrate the ostrich effect, used if the system identifies that a participant is deliberately ignoring relevant or potentially adverse data signals about a selection. For example, if real-time data reveals a significant negative performance indicator for a user-chosen stock, and the user neither modifies the aggregated distribution weighting nor acknowledges the system notifications, the scoreboard or user interface might present ostrich 820. In certain aspects, the system could log how many times a negative shift has occurred that the participant did not even check, employing a hidden field in the structured database to track ignoring patterns. This data might feed into a cumulative weighting penalty or an optional “educational mode” that helps participants see how willful ignorance can degrade average returns, hence aligning with the function outlined in multiple dependent claims for improved user feedback.

In several aspects, the playing cards 822 may denote outcome bias, cautioning participants not to judge a prior choice solely by whether it ended up profitable. The system might detect a user who doubled down on a risky pick that soared once, but who ignores that the initial logic behind the choice was unsound. If the system sees that no real-time data analysis was done, but the user attempts the same approach repeatedly, the playing cards 822 can appear near that user's scoreboard entry. The system might store these events in memory for historical analysis, so that if subsequent identical picks prove disastrous, the user is reminded how outcome bias shapes behavior.

In other aspects, the suited person 824 may embody overconfidence, especially for expert-level participants who either skip recommended eligibility checks or forcibly override system warnings. If the user invests a large aggregated distribution weighting in one asset purely on personal self-assurance, ignoring real-time data that might contradict them, the system might highlight the suited person 824 in the leaderboard or chat integration. This could be integrated with a time-based simulation type, for example, to show that the user's picks persist despite significant negative domain signals. The memory storing instructions for weighting participant entries may scale the severity of a highlight under certain ranking thresholds, consistent with claim elements that mention adjusting a visual representation based on rank movements.

In certain aspects, the pills 826 may represent placebo effect, suggesting that some participants cannot separate genuine performance changes from psychologically induced illusions of success. If the user is only entering picks that “feel right,” ignoring both historical data and real-time updates, the system might show the pills icon in a special “educational overlay” area, referencing this phenomenon. This approach can tie to a user's optional request to enable advanced psychosocial feedback, thereby bridging industrial and international education with cognitive science material. The system might store logs of how often each participant picks items purely by “intuition” rather than referencing the external data source feeds.

In many aspects, the handheld device 828 may stand for pro-innovation bias, wherein participants overvalue novel picks. If the user invests heavily in newly listed assets or cutting-edge geography-linked selections without verifying real-time performance indicator values, the scoreboard or simulation tracking interface could highlight the handheld device 828 as a mild caution. The memory might hold a lineage of how recently each selection was introduced or how much reliable data is available. If the user's weighting logic heavily favors untested picks, the system might automatically adjust the user's final ranking position if that weighting leads to high volatility or if an additional milestone-based rule dictates an adaptation.

In certain aspects, the hourglass 830 may correspond to recency bias, illustrating an overemphasis on the latest data while ignoring older performance trends. If the participant quickly transitions picks from one sector to another each time the external data source signals a short-term spike, the system might display the hourglass 830 to reflect short-sighted or ephemeral data usage. The user management unit could store configuration data that identifies a participant as frequently reacting to any micro-shift. If so, the scoreboard might place a recency bias highlight next to the user's name or picks, reminding them to consider a broader horizon.

In several aspects, the wrecked car 832 may depict salience bias, cautioning participants who place undue focus on dramatic or sensational events. For example, if negative news from a single geography-linked selection does not logically apply to the user's entire aggregated distribution weighting, but the user sells everything in panic, the scoreboard might display the wrecked car 832. This approach can tie into the system's requirement for storing and updating participants' picks. If the user's meltdown was triggered purely by a sensational though irrelevant headline, the system can highlight that salience warp influenced their final ranking.

In other aspects, the football 834 may denote selective perception, referencing a scenario in which the user sees only the data that confirms an expectation of success. If a user invests in a local index purely because that region's sports team is doing well, ignoring negative real-time data in other fields, the scoreboard or chat channel can present the football 834 to highlight this mismatch. This aspect can be combined with an interactive chat module that encourages participants to question whether their perceived synergy has tangible grounding in economic indicators. The memory might log repeated uses of selective perception, optionally factoring that into a reweighted performance ranking if a simulation-defined scoring coefficient is activated.

In certain aspects, the bearded face 836 may show stereotyping, letting a participant see that they are imposing generalized assumptions on categories of picks. If the system identifies a repeated pattern that the user invests only in “established markets” while ignoring smaller or emerging markets, the scoreboard might display the bearded FIG. 836 to reflect how the user may be labeling new picks as “untrustworthy” without verifying real-time data. The user management unit could offer an educational note about how focusing exclusively on major markets might forfeit potential gains from overlooked geographies.

In many aspects, the gavel 838 may represent survivorship bias. If the user invests heavily in picks that soared historically, ignoring those that quietly failed, the system might highlight gavel 838. The structured database might store a full record of prior picks from the external data source, revealing how many have historically disappeared or severely underperformed. The system then references the presence of the gavel 838 to show that the participant's logic might be ignoring the many “losers” no longer visible. The scoreboard or simulation leaderboard can include a sub-entry that draws attention to the concept of survivorship bias, especially if the user is participating in time-based or milestone-based simulations that incorporate the data from multiple years.

In other aspects, the warning sign 840 may designate zero-risk bias, cautioning participants who try to eliminate all risk, perhaps distributing aggregated distribution weightings too evenly or selecting only the safest picks. The system, upon detecting an extremely conservative approach ignoring potential higher-yield selections, can display the warning sign 840. The memory storing instructions might incorporate a tolerance-based factor, so if the user never invests above a certain risk threshold, the scoreboard or interface calls out that zero-risk bias might hamper returns. Because many claims discuss a public interface, the user might optionally choose to hide or reveal these bias-driven icons from other participants, depending on privacy or educational preferences.

In certain aspects, each of these icons 802 through 840 may be integrated with the ephemeral or persistent storage of the simulation system. The system might retrieve them from a database when participants first load or refresh the publicly accessible simulation tracking interface. In many aspects, the system might embed these icons within the at least one real-time data input feed, ensuring that changes in aggregated distribution weightings or participant selection data produce relevant bias alerts. The data retrieval and user management logic might incorporate standard frameworks, for example, Docker-based microservices or cloud-based serverless functions, specifying that updates to the scoreboard are published at intervals of 30 seconds or less.

In several aspects, the icons 802 through 840 might incorporate a multi-language text overlay or “educational mode,” referencing how the simulation platform's industrial and international education components enable a broader audience to apply advanced or intangible aspects of the simulation environment. The system might support a variety of programming frameworks, for example Node.js or Python-based back ends, communicating with a front end in Angular or React. This modular approach may let any user device, from Android phones to iOS tablets, receive timely bias pop-ups or visual highlights triggered by the real-time performance indicator values.

In many aspects, references to “participants,” “aggregated distribution weightings,” or “structured database” remain consistent with the claims. The anchor 802, ash tray 804, and so forth may each serve as ephemeral or persistent educational cues for any number of participants. In certain optional embodiments, each icon can be hidden if the simulation initialization parameters specify a “minimalist” interface, abiding by the claims that allow at least one predefined simulation type. In other optional embodiments, the system might generate a system notification if a user toggles an icon on or off, as well as if new icons are introduced to highlight emergent biases. Potential expansions might define an AI-driven approach that automatically identifies patterns in participant picks that correspond to certain biases, thus continuously calibrating how the icons interface with the user's real-time data feed.

In some embodiments, as illustrated in FIG. 8, various icons may be used to represent different types of cognitive biases that participants may encounter or exhibit during the simulation. These bias representations may be used for educational purposes or to generate visual feedback within the leaderboard or profile interface. Additional embodiments may involve user-generated judgment indicators or visual icons for marking specific simulation events, selections, or decision-making patterns over time.

The following, non-limiting examples, detail certain aspects of the present subject matter to solve the challenges and provide the benefits discussed herein, among others.

Example 1 is at least one non-transitory machine-readable medium including instructions, which when executed by processing circuitry, cause the processing circuitry to perform operations to: receive at least one simulation initialization parameter associated with a simulation from a first user device, wherein the at least one simulation initialization parameter defines a simulation structure including a predefined number of simulation participants, an open selection pool of a plurality of geography-linked selections, one or more scoring metrics based on at least one real-time data input, and a simulation duration; store the at least one simulation initialization parameter in a structured database, wherein each simulation is assigned a unique simulation identifier; receive participant selection data, the participant selection data corresponding to at least one predefined simulation rule and including a selection of at least one geography-linked selection, wherein the selection of at least one geography-linked selection may be chosen by one or more participant aggregated distribution weightings; associate the participant selection data with the unique simulation identifier to generate a relational mapping of the one or more participant aggregated distribution weightings within the structured database; obtain the at least one real-time data input from at least one external data source, wherein the at least one external data source provides dynamically updating performance indicator values corresponding to the participant selection data; apply at least one predefined computation rule to the at least one real-time data input to generate a performance ranking for the one or more participant aggregated distribution weightings, wherein the performance ranking is dynamically updated throughout the simulation duration; assign a ranking position to the one or more participant aggregated distribution weightings based on the performance ranking; and generate a publicly accessible simulation tracking interface including a simulation leaderboard, wherein the simulation leaderboard dynamically updates the performance ranking of the one or more participant aggregated distribution weightings based on the at least one real-time data input.

In Example 2, the subject matter of Example 1 includes, wherein the at least one simulation initialization parameter further comprises at least one predefined simulation type selected from a group consisting of: time-based simulations, performance-based simulations, and milestone-based simulations.

In Example 3, the subject matter of Examples 1-2 includes, wherein receiving the participant selection data further comprises validating the participant selection data against at least one predefined eligibility criterion before associating the participant selection data with the unique simulation identifier.

In Example 4, the subject matter of Examples 1-3 includes, wherein computing the at least one real-time data input further comprises retrieving historical performance data from the at least one external data source to generate predictive performance insights for the one or more participant aggregated distribution weightings.

In Example 5, the subject matter of Examples 1-4 includes, wherein formatting the simulation leaderboard using at least one visual highlighting technique further comprises dynamically adjusting a visual representation of the simulation leaderboard based on at least one ranking threshold.

In Example 6, the subject matter of Examples 1-5 includes, wherein a unique URL associated with the simulation leaderboard is configured to allow limited-time access.

In Example 7, the subject matter of Examples 1-6 includes, wherein the publicly accessible simulation tracking interface further comprises an interactive chat module that enables authenticated users to exchange messages related to the simulation within a secure communication channel.

In Example 8, the subject matter of Examples 1-7 includes, wherein the at least one predefined computation rule applied to the at least one real-time data input further comprises weighting participant entries based on a simulation-defined scoring coefficient to account for variations in selection difficulty.

In Example 9, the subject matter of Examples 1-8 includes, generating at least one artificial participant entry using a randomly selected performance indicator values.

In Example 10, the subject matter of Examples 1-9 includes, wherein the simulation leaderboard is formatted using at least one visual highlighting technique to differentiate the ranking position based on the performance ranking.

In Example 11, the subject matter of Example 10 includes, wherein formatting the simulation leaderboard using at least one visual highlighting technique further comprises dynamically adjusting a visual representation of the simulation leaderboard based on one or more ranking thresholds.

In Example 12, the subject matter of Examples 1-11 includes, generating a system notification in response to detecting a modification of the at least one predefined simulation rule, wherein the system notification is transmitted to one or more user devices associated with one or more simulation participants.

Example 13 is a method comprising: receiving at least one simulation initialization parameter associated with a simulation from a first user device, wherein the at least one simulation initialization parameter defines a simulation structure including a predefined number of simulation participants, an open selection pool of a plurality of geography-linked selections, one or more scoring metrics based on at least one real-time data input, and a simulation duration; storing the at least one simulation initialization parameter in a structured database, wherein each simulation is assigned a unique simulation identifier; receiving participant selection data, the participant selection data corresponding to at least one predefined simulation rule and including a selection of at least one geography-linked selection, wherein the selection of at least one geography-linked selection may be chosen by one or more participant aggregated distribution weightings; associating the participant selection data with the unique simulation identifier to generate a relational mapping of the one or more participant aggregated distribution weightings within the structured database; obtaining the at least one real-time data input from at least one external data source, wherein the at least one external data source provides dynamically updating performance indicator values corresponding to the participant selection data; applying at least one predefined computation rule to the at least one real-time data input to generate a performance ranking for the one or more participant aggregated distribution weightings, wherein the performance ranking is dynamically updated throughout the simulation duration; assigning a ranking position to the one or more participant aggregated distribution weightings based on the performance ranking; and generating a publicly accessible simulation tracking interface including a simulation leaderboard, wherein the simulation leaderboard dynamically updates the performance ranking of the one or more participant aggregated distribution weightings based on the at least one real-time data input.

In Example 14, the subject matter of Example 13 includes, wherein the at least one simulation initialization parameter further comprises at least one predefined simulation type selected from a group consisting of time-based simulations, performance-based simulations, and milestone-based simulations.

In Example 15, the subject matter of Examples 13-14 includes, wherein receiving the participant selection data further comprises validating the participant selection data against at least one predefined eligibility criterion before associating the participant selection data with the unique simulation identifier.

Example 16 is a system comprising: processing circuitry; and memory, including instructions, which when executed by the processing circuitry, causes the processing circuitry to: receive at least one simulation initialization parameter associated with a simulation from a first user device, wherein the at least one simulation initialization parameter defines a simulation structure including a predefined number of simulation participants, an open selection pool of a plurality of geography-linked selections, one or more scoring metrics based on at least one real-time data input, and a simulation duration; store the at least one simulation initialization parameter in a structured database, wherein each simulation is assigned a unique simulation identifier; receive participant selection data, the participant selection data corresponding to at least one predefined simulation rule and including a selection of at least one geography-linked selection, wherein the selection of a geography-linked selection may be chosen by one or more participant aggregated distribution weightings; associate the participant selection data with the unique simulation identifier to generate a relational mapping of the one or more participant aggregated distribution weightings within the structured database; obtain the at least one real-time data input from at least one external data source, wherein the at least one external data source provides dynamically updating performance indicator values corresponding to the participant selection data; apply at least one predefined computation rule to the at least one real-time data input to generate a performance ranking for the one or more participant aggregated distribution weightings, wherein the performance ranking is dynamically updated throughout the simulation duration; assign a ranking position to the one or more participant aggregated distribution weightings based on the performance ranking;

and generate a publicly accessible simulation tracking interface including a simulation leaderboard, wherein the simulation leaderboard dynamically updates the performance ranking of the one or more participant aggregated distribution weightings based on the at least one real-time data input.

In Example 17, the subject matter of Example 16 includes, transmitting a unique URL associated with the simulation leaderboard to a second user device, wherein the unique URL provides real-time access to the simulation leaderboard.

The system of Example 16, wherein the unique URL associated with the simulation leaderboard is configured to allow the unique URL to expire after a predefined duration or upon simulation completion.

In Example 18, the subject matter of Examples 16-17 includes, wherein the processing circuitry is further configured to retrieve historical performance data from the at least one external data source to generate one or more predictive performance insights for the one more participant aggregated distribution weightings.

In Example 19, the subject matter of Examples 16-18 includes, wherein the simulation includes at least one bot participant configured to transmit participant selection data according to a predefined algorithmic strategy.

Example 20 is at least one machine-readable medium including instructions that, when executed by processing circuitry, cause the processing circuitry to perform operations to implement of any of Examples 1-19.

Example 21 is an apparatus comprising means to implement of any of Examples 1-19.

Example 22 is a system to implement of any of Examples 1-19.

Example 23 is a method to implement of any of Examples 1-19.

What is claimed is:

1. At least one non-transitory machine-readable medium including instructions, which when executed by processing circuitry, cause the processing circuitry to perform operations to:
receive at least one simulation initialization parameter associated with a simulation from a first user device, wherein the at least one simulation initialization parameter defines a simulation structure including a predefined number of simulation participants, an open selection pool of a plurality of geography-linked selections, one or more scoring metrics based on at least one real-time data input, and a simulation duration;
store the at least one simulation initialization parameter in a structured database, wherein each simulation is assigned a unique simulation identifier;
receive participant selection data, the participant selection data corresponding to at least one predefined simulation rule and including a selection of at least one geography-linked selection, wherein the selection of at least one geography-linked selection may be chosen by one or more participant aggregated distribution weightings;
associate the participant selection data with the unique simulation identifier to generate a relational mapping of the one or more participant aggregated distribution weightings within the structured database;
obtain the at least one real-time data input from at least one external data source, wherein the at least one external data source provides dynamically updating performance indicator values corresponding to the participant selection data;
apply at least one predefined computation rule to the at least one real-time data input to generate a performance ranking for the one or more participant aggregated distribution weightings, wherein the performance ranking is dynamically updated throughout the simulation duration;
assign a ranking position to the one or more participant aggregated distribution weightings based on the performance ranking; and
generate a publicly accessible simulation tracking interface including a simulation leaderboard, wherein the simulation leaderboard dynamically updates the performance ranking of the one or more participant aggregated distribution weightings based on the at least one real-time data input.

2. The at least one non-transitory machine-readable medium of claim 1, wherein the at least one simulation initialization parameter further comprises at least one predefined simulation type selected from a group consisting of: time-based simulations, performance-based simulations, and milestone-based simulations.

3. The at least one non-transitory machine-readable medium of claim 1, wherein receiving the participant selection data further comprises validating the participant selection data against at least one predefined eligibility criterion before associating the participant selection data with the unique simulation identifier.

4. The at least one non-transitory machine-readable medium of claim 1, wherein computing the at least one real-time data input further comprises retrieving historical performance data from the at least one external data source to generate predictive performance insights for the one or more participant aggregated distribution weightings.

5. The at least one non-transitory machine-readable medium of claim 1, wherein formatting the simulation leaderboard using at least one visual highlighting technique further comprises dynamically adjusting a visual representation of the simulation leaderboard based on at least one ranking threshold.

6. The at least one non-transitory machine-readable medium of claim 1, wherein a unique URL associated with the simulation leaderboard is configured to allow limited-time access.

7. The at least one non-transitory machine-readable medium of claim 1, wherein the publicly accessible simulation tracking interface further comprises an interactive chat module that enables authenticated users to exchange messages related to the simulation within a secure communication channel.

8. The at least one non-transitory machine-readable medium of claim 1, wherein the at least one predefined computation rule applied to the at least one real-time data input further comprises weighting participant entries based on a simulation-defined scoring coefficient to account for variations in selection difficulty.

9. The at least one non-transitory machine-readable medium of claim 1, further comprising generating at least one artificial participant entry using a randomly selected performance indicator values.

10. The at least one non-transitory machine-readable medium of claim 1, wherein the simulation leaderboard is formatted using at least one visual highlighting technique to differentiate the ranking position based on the performance ranking.

11. The at least one non-transitory machine-readable medium of claim 10, wherein formatting the simulation leaderboard using at least one visual highlighting technique further comprises dynamically adjusting a visual representation of the simulation leaderboard based on one or more ranking thresholds.

12. The at least one non-transitory machine-readable medium of claim 1, further comprising generating a system notification in response to detecting a modification of the at least one predefined simulation rule, wherein the system notification is transmitted to one or more user devices associated with one or more simulation participants.

13. A method comprising:
receiving at least one simulation initialization parameter associated with a simulation from a first user device, wherein the at least one simulation initialization parameter defines a simulation structure including a predefined number of simulation participants, an open selection pool of a plurality of geography-linked selections, one or more scoring metrics based on at least one real-time data input, and a simulation duration;
storing the at least one simulation initialization parameter in a structured database, wherein each simulation is assigned a unique simulation identifier;
receiving participant selection data, the participant selection data corresponding to at least one predefined simulation rule and including a selection of at least one geography-linked selection, wherein the selection of at least one geography-linked selection may be chosen by one or more participant aggregated distribution weightings;
associating the participant selection data with the unique simulation identifier to generate a relational mapping of the one or more participant aggregated distribution weightings within the structured database;
obtaining the at least one real-time data input from at least one external data source, wherein the at least one external data source provides dynamically updating performance indicator values corresponding to the participant selection data;
applying at least one predefined computation rule to the at least one real-time data input to generate a performance ranking for the one or more participant aggregated distribution weightings, wherein the performance ranking is dynamically updated throughout the simulation duration;
assigning a ranking position to the one or more participant aggregated distribution weightings based on the performance ranking; and
generating a publicly accessible simulation tracking interface including a simulation leaderboard, wherein the simulation leaderboard dynamically updates the performance ranking of the one or more participant aggregated distribution weightings based on the at least one real-time data input.

14. The method of claim 13, wherein the at least one simulation initialization parameter further comprises at least one predefined simulation type selected from a group consisting of time-based simulations, performance-based simulations, and milestone-based simulations.

15. The method of claim 13, wherein receiving the participant selection data further comprises validating the participant selection data against at least one predefined eligibility criterion before associating the participant selection data with the unique simulation identifier.

16. A system comprising:
processing circuitry; and
memory, including instructions, which when executed by the processing circuitry, causes the processing circuitry to:
receive at least one simulation initialization parameter associated with a simulation from a first user device, wherein the at least one simulation initialization parameter defines a simulation structure including a predefined number of simulation participants, an open selection pool of a plurality of geography-linked selections, one or more scoring metrics based on at least one real-time data input, and a simulation duration;
store the at least one simulation initialization parameter in a structured database, wherein each simulation is assigned a unique simulation identifier;
receive participant selection data, the participant selection data corresponding to at least one predefined simulation rule and including a selection of at least one geography-linked selection, wherein the selection of a geography-linked selection may be chosen by one or more participant aggregated distribution weightings;
associate the participant selection data with the unique simulation identifier to generate a relational mapping of the one or more participant aggregated distribution weightings within the structured database;
obtain the at least one real-time data input from at least one external data source, wherein the at least one external data source provides dynamically updating performance indicator values corresponding to the participant selection data;
apply at least one predefined computation rule to the at least one real-time data input to generate a performance ranking for the one or more participant aggregated distribution weightings, wherein the performance ranking is dynamically updated throughout the simulation duration;
assign a ranking position to the one or more participant aggregated distribution weightings based on the performance ranking; and
generate a publicly accessible simulation tracking interface including a simulation leaderboard, wherein the simulation leaderboard dynamically updates the performance ranking of the one or more participant aggregated distribution weightings based on the at least one real-time data input.

17. The system of claim 16, further comprising transmitting a unique URL associated with the simulation leaderboard to a second user device, wherein the unique URL provides real-time access to the simulation leaderboard.

18. The system of claim 17, wherein the unique URL associated with the simulation leaderboard is configured to allow the unique URL to expire after a predefined duration or upon simulation completion.

19. The system of claim 16, wherein the processing circuitry is further configured to retrieve historical performance data from the at least one external data source to generate one or more predictive performance insights for one more participant aggregated distribution weightings.

20. The system of claim 16, wherein the simulation includes at least one bot participant configured to transmit participant selection data according to a predefined algorithmic strategy.
